(19) United States
(12) Patent Application Publication
(10) Pub. No.: US 2017/0076054 A1
(43) Pub. Date: Mar. 16, 2017

(54) PARTICLE ANALYSIS SYSTEMS AND METHODS

(71) Applicant: IRIS International, Inc., Chatsworth, CA (US)

(72) Inventors: Jon F. Tindel, Valley Village, CA (US); Jun Yang, Agoura Hills, CA (US)

(73) Assignee: IRIS International, Inc., Chatsworth, CA (US)

(21) Appl. No.: 15/238,952

(22) Filed: Aug. 17, 2016

Related U.S. Application Data
(60) Provisional application No. 62/216,895, filed on Sep. 10, 2015.

(51) Int. Cl. G06F 19/00

(52) U.S. Cl. CPC G06F 19/326; G06F 19/3487

(57) ABSTRACT

In some embodiments, a method is provided for returning medical data comprising a test result from a particle analyzer including receiving a clinical data query in an initial format from an input object. After receiving the clinical data query, transforming the clinical data query into multiple different query types, each different query type having a different format from the initial format, each different query type for querying a different medical database or object graph in memory. Querying the medical databases using one of the query types based on the medical database. In response to the querying, receiving the data sets from the medical databases including the test result from the particle analyzer. Once data sets are received, output at least some information from the data sets.

### CROSS REFERENCE TO RELATED APPLICATIONS

This application claims the benefit of and priority to U.S. Provisional Patent Application No. 62/216,895, entitled PARTICLE ANALYSIS SYSTEMS AND METHODS, filed Sep. 10, 2015, which is incorporated herein by reference in its entirety for all purposes.

### BACKGROUND OF THE INVENTION

The present disclosure relates generally to the field of performing particle analysis using a computing device. More specifically, but not by way of limitation, this disclosure relates to a computing device for performing particle analysis using transformed clinical data queries.

### BRIEF SUMMARY OF THE INVENTION

In some embodiments, a method, medical device, or computer code (i.e., computer instructions) is provided for returning medical data comprising a test result from a particle analyzer including receiving a clinical data query in an initial format from an input object. After receiving the clinical data query, transforming the clinical data query into multiple different query types, each different query type having a different format from the initial format, each different query type for querying a different medical database or object graph in memory. Querying the medical databases using one of the query types based on the medical database. In response to the querying, receiving the data sets from the medical databases including the test result from the particle analyzer. Once data sets are received, output at least some information from the data sets.

Optionally, the method can also include having the particle analyzer perform a particle analysis on a medical test sample to generate the test result. The test result can be formatted into a data type usable with at least one of the medical databases. The test result can also be stored in at least one of the medical databases. Optionally, a graphical user interface (“GUI”) can be output for display such that the GUI can include an input object having an input field. The GUI can also display at least some information from the data sets.

Optionally, a threshold for a parameter of the test result can be received via the GUI for a urinalysis test result. The threshold parameter can be a white blood cell count or an amount of bacteria. The method can include determining if the parameter of the test result exceeds the threshold and, if so, changing a color of a GUI component or changing a location on a display device of the GUI component. The method can also including receiving a second threshold for a number of urinary casts of the test result via the GUI. If the sample includes a value for the number of urinary casts exceeding the threshold, a characteristic of the GUI can be modified in response.

Optionally, the method can include querying the medical databases by querying associated remote servers containing the medical databases. Optionally, the remote servers are each associated with a different medical healthcare provider.

### BRIEF DESCRIPTION OF THE DRAWINGS

A further understanding of the nature and advantages of various examples may be realized by reference to the following figures.

FIG. 1 illustrates a flow chart of an example of a process for performing particle analysis using transformed clinical data queries according to some aspects.

FIG. 2 illustrates a block diagram of an example of a computing device usable for performing particle analysis using transformed clinical data queries according to some aspects.

FIG. 3 illustrates a block diagram of an example of a system usable for performing particle analysis using transformed clinical data queries according to some aspects.

FIGS. 4-9 illustrate examples of GUIs for performing particle analysis using transformed clinical data queries according to some aspects.

FIG. 10 illustrates a diagram of key entity types usable by a system for performing particle analysis using transformed clinical data queries according to some aspects.

FIGS. 11-19 illustrate examples of GUIs for performing particle analysis using transformed clinical data queries according to some aspects.

FIGS. 20A and 20B illustrate query precedence based on grouping or ungrouping queries.

### DETAILED DESCRIPTION OF THE INVENTION

Aspects of the present disclosure include a flexible test results query and rules management system. The overall domain specific language (“DSL”) based design can offer a general approach to handle both querying data in one or more databases and data in in-memory objects. Using the flexible entity model and dynamic test menus described herein can allow for dynamic customization without requiring software code changes. A test menu can be a set of configuration information that identifies the available fields for creation of a query as described in more detail herein.

Aspects of the present disclosure include a query builder. The query builder can be provided, at least in part, via a user friendly graphical user interface (“GUI”), allowing a user to construct simple or complex query criteria. In some examples, the user can construct a simple or complex query utilizing the customized test menus. Additional or alternative ease-of-use features can include: TreeListView based user interface (“UI”) control, reverse mapping of test menus, usage of external variables, allowing referencing other queries, and the like.

Different customers may use a set of slightly different settings to make decisions. The system can provide users an easy to use GUI for them to build and customize queries. With a flexible test menu configuration system in place, a query builder can take advantage of the dynamic content provided via user customized test menus and build rules on top of them.

In some examples, third party libraries, such as Sprache, BreadcrumbBar, TreeList, Valuelnjecter, Xceed.Wpf Toolkit, together with Microsoft's Entity Framework technologies, can be used to implement aspects.

Aspects of the present disclosure include an on-board middle-ware component that can provide decision making engines for affecting the general sample workflow. For example, a urinalysis test result of a sample that indicates the sample includes a high white blood cell (“WBC”) count, lots of small particles, or some amount of bacteria can be flagged for further review as a possible urinary tract infection (“UTI”) candidate. A sample that indicates no issues can instead be auto-released.

Some desirable attributes for a system of the present disclosure include: a user friendly GUI that is intuitive and through which it is relatively easy for a user to create and/or edit arbitrarily complex queries; a flexible GUI that is readily adapted for test menus; a portable system that is easy to replicate in an environment for testing and development and for sharing queries among end users; a backwards compatible system that can support entity model changes, dynamic test parameters, and flexible test menus with minimal changes to the system software; and a multi-targeting usage (or reusable) system that can allow the same query to be used for searching, filtering, or generating result affecting a workflow (i.e., rule actions)

Unless expressly indicated otherwise, references to “particle” or “particles” made in this disclosure will be understood to encompass any discrete or formed object dispersed in a fluid. As used herein, “particle” can include all measurable and detectable (e.g., by image and/or other measurable parameters) components in biological fluids. The particles are of any material, any shape, and any size. Particles can comprise cells. Examples of particles include but are not limited to cells, including blood cells, fetal cells, epithelials, stem cells, tumor cells, or bacteria, parasites, or fragments of any of the foregoing or other fragments in a biological fluid. Blood cells may be any blood cell, including any normal or abnormal, mature or immature cells which potentially exist in a biological fluid, for example, red blood cells (“RBCs”), white blood cells (“WBCs”), platelets (“PLTs”) and other cells. The members also include immature or abnormal cells. Immature WBCs may include metamyelocytes, myelocytes, pro-myelocytes, and blasts. In addition to mature RBCs, members of RBCs may include nucleated RBCs (“NTRCs”) and reticulocytes. PLTs may include “giant” PLTs and PLT clumps. Throughout the specification, the images are described as being an image of a cell or a particle. Though referred to as a cell in many cases, the images can be of any particle. Platelets, reticulocytes, nucleated RBCs, and WBCs, including neutrophils, lymphocytes, monocytes, eosinophils, basophils, and immature WBCs including blasts, promyelocytes, myelocytes, or metamyelocytes are counted and analyzed as particles.

Exemplary urine particles can include urine sediment particles. Exemplary urine sediment particles can include erythrocytes (e.g., RBCs), dysmorphic erythrocytes, leukocytes (e.g., WBCs), neutrophils, lymphocytes, phagocytic cells, eosinophils, basophils, squamous epithelial cells, transitional epithelial cells, decoy cells, renal tubular epithelial cells, casts, crystals, bacteria, yeast, parasites, oval fat bodies, fat droplets, spermatozoa, mucus, trichomonas, cell clumps, and cell fragments. Exemplary cells can include red blood cells, white blood cells, and epithelials. Exemplary casts can include acellular pigment casts, unclassified cast (e.g., granular casts). Exemplary acellular casts can include, for example, waxy casts, broad casts, fatty casts, and crystal casts. Exemplary cellular casts can include, for example, RBC casts, WBC casts, and cellular casts. Exemplary crystals can include, for example, calcium oxalate, triple phosphate, calcium phosphate, uric acid, calcium carbonate, leucine, cystine, tyrosine, and amorphous crystals. Exemplary non-squamous epithelial cells can include, for example, renal epithelials and transitional epithelials. Exemplary yeast can include, for example, budding yeast and yeast with pseudohyphae. Exemplary urinary sediment particle can also include RBC clumps, fat, oval fat bodies, and trichomonas. The described systems and methods may be useful, for example, in characterizing particles in biological fluids, such as detecting and quantifying erythrocytes (e.g., RBCs), dysmorphic erythrocytes, leukocytes (e.g., WBCs), neutrophils, lymphocytes, phagocytic cells, eosinophils, basophils, squamous epithelial cells, transitional epithelial cells, decoy cells, renal tubular epithelial cells, casts, crystals, bacteria, yeast, parasites, oval fat bodies, fat droplets, spermatozoa, mucus, trichomonas, cell clumps, and cell fragments, categorization and subcategorization, counting and analysis.

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. Optionally, the systems may be configured as a distributed system where one or more components of the system are distributed across one or more networks in a cloud computing system. All features of the described systems are applicable to the described methods mutatis mutandis, and vice versa.

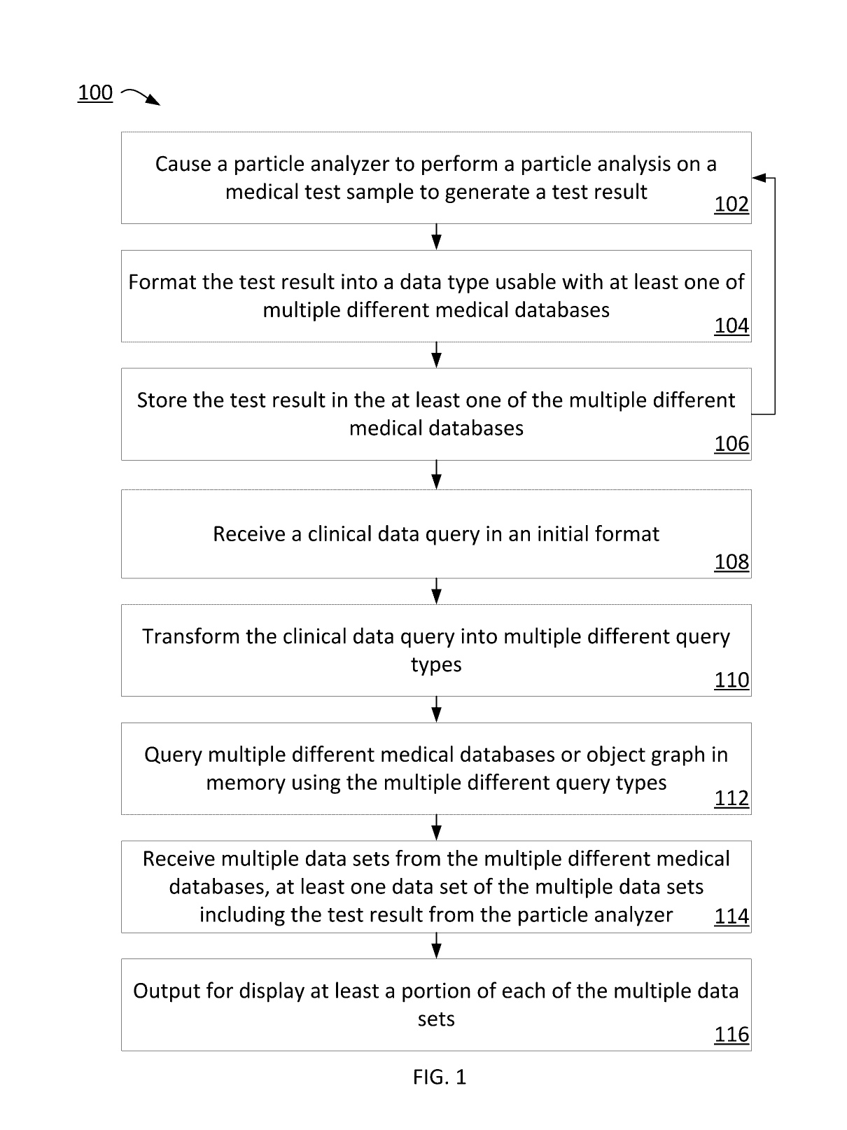

FIG. 1 illustrates a flow chart of an example of a process for performing particle analysis using transformed clinical data queries according to some aspects. The steps in FIG. 1 may be implemented in program code that is executed by one or more processors, for example, the processor in a general purpose computer, a mobile device, or a server. In some examples, one or more steps shown in FIG. 1 may be omitted or performed in a different order. Similarly, additional steps not shown in FIG. 1 may also be performed.

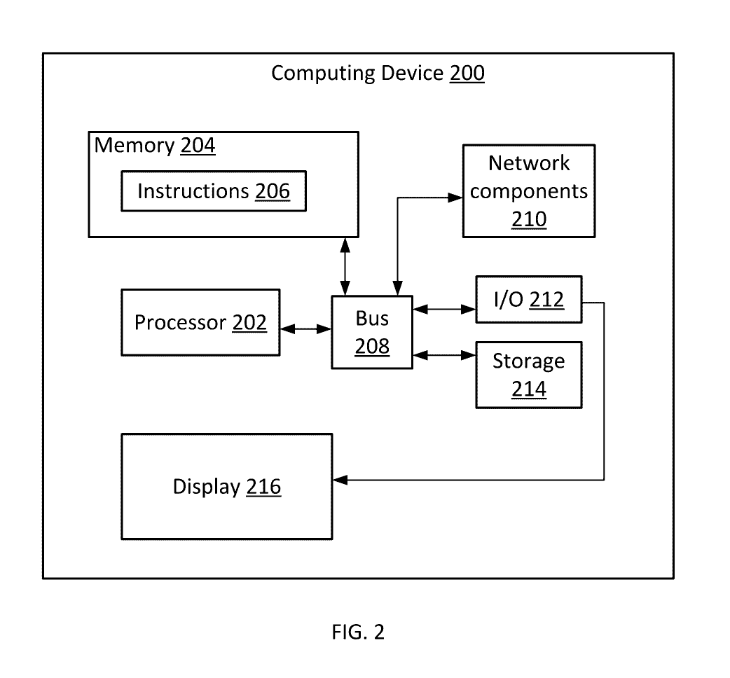

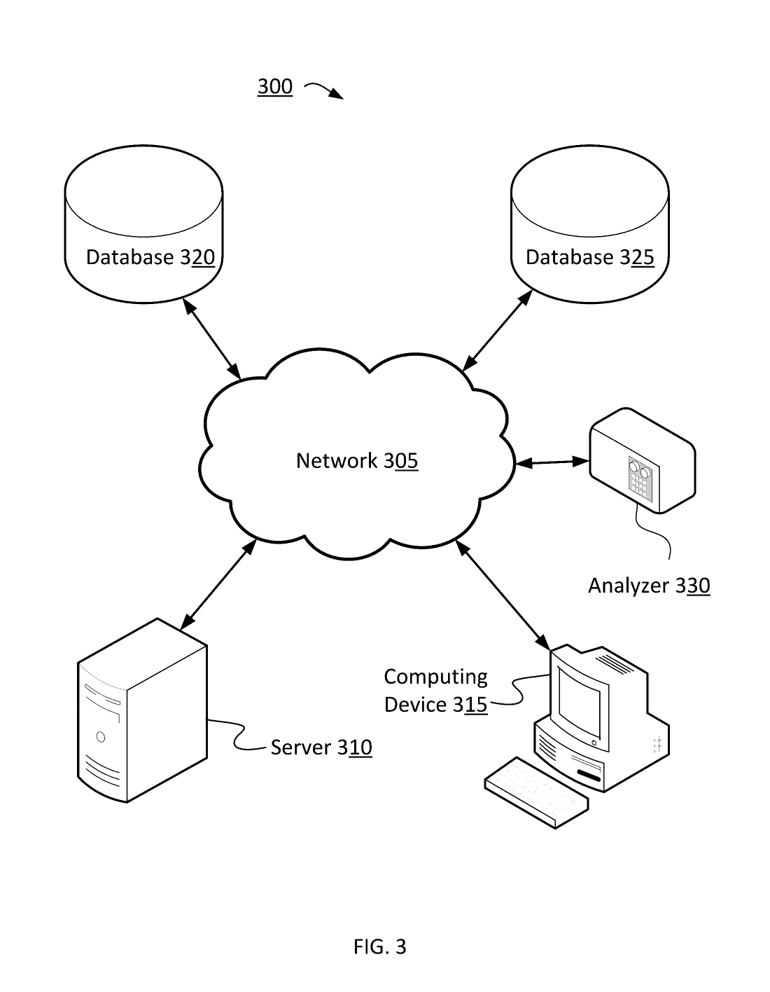

In block 102, a processor (e.g., processor 202 of FIG. 2) causes a particle analyzer (e.g., particle analyzer 330 of FIG. 3) to perform a particle analysis on a medical test sample to generate a test result. The processor can be included within the particle analyzer or separate from the particle analyzer. The particle analyzer can detect one or more characteristics of one or more particles in the medical test sample. For example, the particle analyzer can detect a number, type, shape, and/or size of one or more particles in the medical test sample. The particle analyzer can provide a test result indicating the one or more characteristics of the one or more particles. Exemplary particle analyzers can include systems or features such as those described in U.S. Patent Application Nos. 61/799,014 and 61/799,152 filed Mar. 15, 2013, U.S. patent application Ser. Nos. 14/215,834, 14/216,339, 14/216,533, 14/216,562, 14/216,811, 14/217,034, and 14/217,228 filed Mar. 17, 2014, and International Patent Application No. PCT/US14/30942 filed Mar. 18, 2014. The content of each of the above filings is incorporated herein by reference.

In block 104, the processor formats the test result into a data type usable with at least one of multiple different medical databases or object graphs in memory. For example, the processor can format the test result into a string, integer, Boolean, binary value, floating point, and/or other data type. In some examples, the processor can format the test result into a data type and/or query string usable with a particular database. For example, the processor can format the test result into a char, varchar, tinytext, text, blob, mediumtext, mediumblob, longtext, longblob, enum, and/or any other datatype or query string usable with a MySQL database, Oracle database, or any other structured query language (“SQL”) or non-SQL database.

In block 106, the processor stores the test result in the at least one of the multiple different medical databases or object graphs in memory. For example, the processor can transmit the formatted test result to a remote server comprising a medical database. The remote server can cause the formatted test result to be stored in the medical database. In other examples, the processor can transmit the formatted result to the medical database, which can responsively store the test result.

In block 108, the processor can receive a clinical data query in an initial format. The initial format can include, for example, a Boolean format and/or logical expression. The processor can receive the clinical data query from an input object of a GUI, such as an input box, text field, or other GUI interface object. The processor can additionally or alternatively receive the clinical data query from an input device (e.g., a keyboard, mouse, touch-screen, touch-pad, and the like).

In block 110, the processor can transform the clinical data query into multiple different query types. The multiple different query types can include different formats from the initial format. For example, the processor can transform a clinical data query from an initial format of, for example, a logical expression into a query string usable for querying, for example, a MySQL database. The multiple different query types can be usable to query one or more medical databases (e.g., databases 320 and 325 of FIG. 3). As other examples, the transformation from the initial format can be into a char, varchar, tinytext, text, blob, mediumtext, mediumblob, longtext, longblob, enum, and/or another data type or a query string usable with a MySQL database, Oracle database, and/or any other SQL or non-SQL database.

In block 112, the processor queries multiple different medical databases or object graphs in memory using the multiple different query types. For example, the processor can transmit each of the query types to a different medical database and/or server. Each medical database and/or server can responsively retrieve a data set associated with a received query and transmit the data set to the processor.

In block 114, the processor receives multiple data sets from the multiple different medical databases or object graphs in memory. In some examples, at least one data set provided by a medical database and/or server can include at least a portion of the test result from the particle analyzer.

In block 116, the processor outputs for display at least a portion of each of the multiple data sets. In some examples, the processor outputs a portion of, or all of, the test result from the particle analyzer. Optionally, the output for display can be via a GUI, as described in more detail herein. Optionally, the output for display can be displayed to a user via a GUI on a display such as display 216 of FIG. 2.

FIG. 2 illustrates a block diagram of an example of a computing device 200 usable for performing particle analysis using transformed clinical data queries according to some aspects. The computing device 200 can be or include, for example, a laptop computer, desktop computer, tablet, e-reader, smart watch, smart phone or mobile device, or other electronic device.

The computing device 200 can include a processor 202 interfaced with other hardware via a bus 208. A memory 204, which can include any suitable tangible (and non-transitory) computer readable medium, such as RAM, ROM, EEPROM, or the like, can embody program components (e.g., instructions 206) that configure operation of the computing device 200. In some examples, the computing device 200 can include input/output (“I/O”) interface components 212 (e.g., for interfacing with a display 216, keyboard, or mouse) and additional storage 214.

The computing device 200 can include network components 210. Network components 210 can represent one or more of any components that facilitate a network connection. In some examples, the network components 210 can facilitate a wireless connection and include wireless interfaces such as IEEE 802.11, Bluetooth, or radio interfaces for accessing cellular telephone networks (e.g., a transceiver/antenna for accessing CDMA, GSM, UMTS, or other mobile communications network). In other examples, the network components 210 can be wired and can include interfaces such as Ethernet, USB, or IEEE 1394.

Although FIG. 2 depicts a single computing device 200 with a single processor 202, the system can include any number of computing devices 200 and any number of processors 202. For example, multiple computing devices 200 or multiple processors 202 can be distributed over a wired or wireless network (e.g., a Wide Area Network, Local Area Network, or the Internet). The multiple computing devices 200 or multiple processors 202 can perform any of the steps of the present disclosure individually or in coordination with one another. For example, the processor 202 and/or the computing device 200 can perform any of the steps described above with respect to FIG. 1.

FIG. 3 illustrates a block diagram of an example of a system 300 usable for performing particle analysis using transformed clinical data queries according to some aspects. The system 300 can include one or more computing devices 315, which can be computing device 200 of FIG. 2. Although depicted in FIG. 3 as a desktop computer, as discussed with respect to FIG. 2, the computing device 315 can be or include a laptop computer, tablet, e-reader, smart watch, smart phone or mobile device, or other electronic device.

Though only two are shown, the system 300 can include any number of databases 320 and 325. The databases 320 and 325 can be, for example, medical databases that comprise medical data about one or more patients. The databases can be configured for use with any type of database software or database management system, such as a MySQL database, Oracle database, or any other type of SQL or non-SQL database. In some examples, one or more of the databases 320 and 325 can be coupled to a server 310. Though only one server 310 is shown, there can be any number of servers 310. Although shown separately, server 110 can be placed, for example, between database 320 and network 305. Optionally, each database 320 and 325 can be coupled to a corresponding server 310. The server 310 can store data within, retrieve data from, or otherwise control the operation of one or more associated databases 320 and 325. In some examples, each server 310 can be associated with a different medical healthcare provider (e.g., a doctor's office, hospital, transitional care facility, and/or testing facility). In other examples, at least two of the servers 310 can be associated with the same medical healthcare provider.

The system 300 can include a particle analyzer 330. The particle analyzer 330 can be configured to analyze multiple particles from a medical test sample. The particle analyzer 330 can analyze any number and configuration of characteristics of particles within the medical test sample. The particle analyzer 330 can generate a test report indicating the characteristics of the medical test sample. In some examples, the particle analyzer 330 can transmit data associated with the test report to one or more of the databases 320 and 325.

The system 300 can include a network 305. The network 305 can be any suitable number or type of networks or links, including, but not limited to, a dial-up network, a local area network (“LAN”), wide area network (“WAN”), public switched telephone network (“PSTN”), a cellular network, a WiFi network, the Internet, an intranet or any combination of hard-wired and/or wireless communication links. The network 305 can include one or more sub-networks. In some examples, two or more components of the system (e.g., the computing device 200, server 310, databases 320 and 325, particle analyzer 330, or any combination of these) can be connected to, and communicate via, the network 305.

Certain aspects and features of the present disclosure provide a GUI for generating one or more user-customizable rules for analyzing test results from a particle analyzer. In some examples, the GUI can output information associated with the test results.

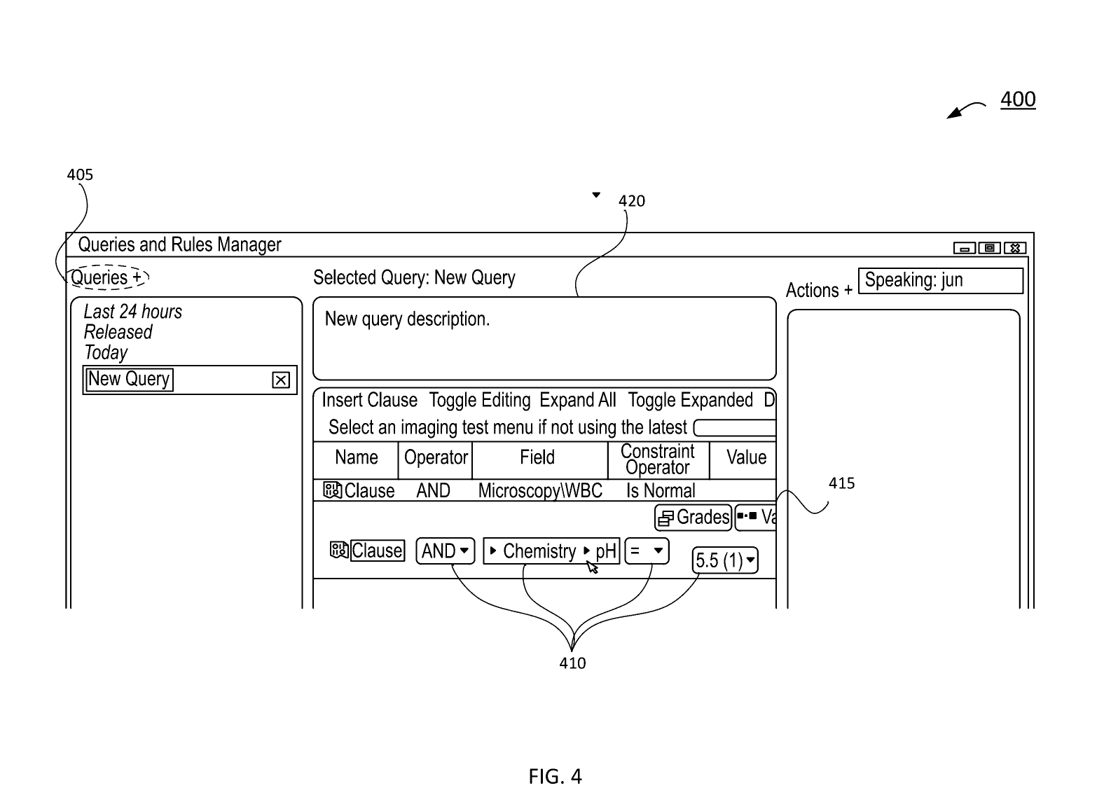

In some examples, the GUI can include one or more interface components for allowing a user to build a custom set of rules for analyzing test results from a particle analyzer. For example, referring now to FIG. 4, the GUI 400 can include multiple user interface components, including menus, text fields, text boxes, buttons, sliders, scroll bars, icons, and images. In some examples, a user can build a custom rule by selecting a “New Query” option from, for example, a drop-down menu that can be displayed by selecting the queries selection item 405. The user can build the custom rule, at least in part, by selecting options from multiple drop-down menus 410 within a table 415 of the GUI 400. In some examples, the custom rule can include a logical expression. Optionally, a user can provide a description of the query in query description text box 420.

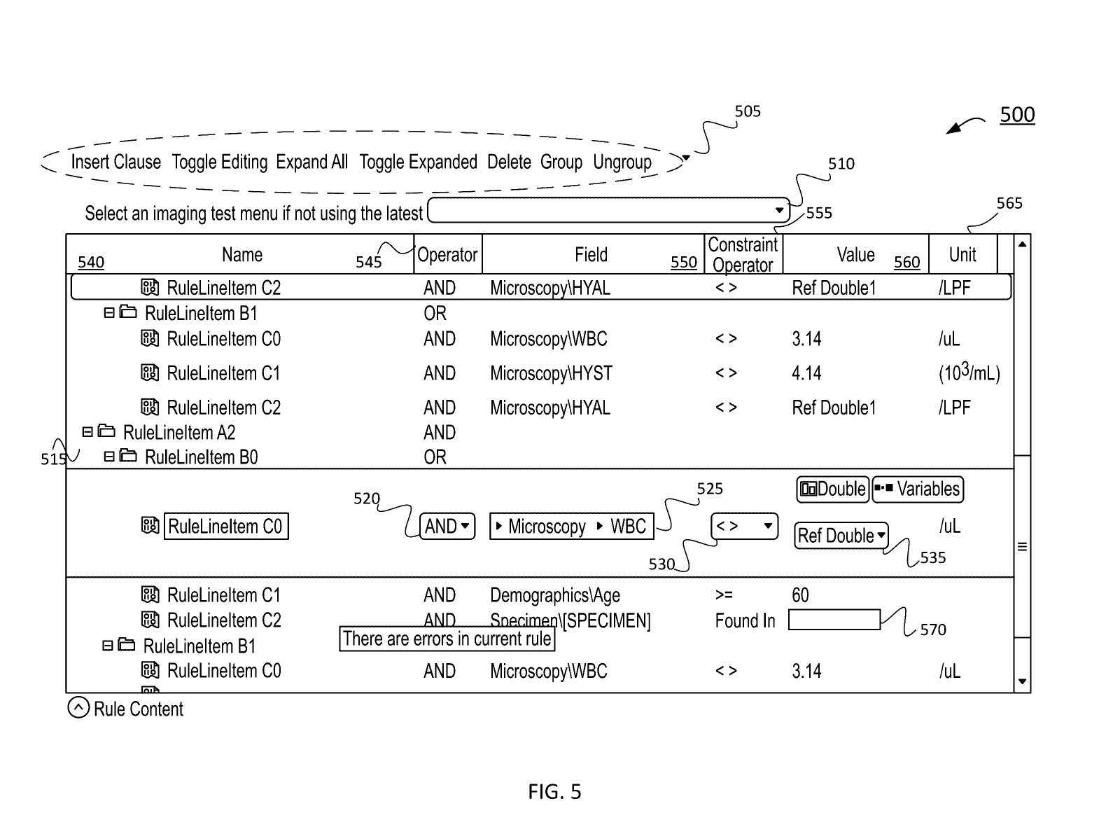

FIG. 5 depicts a portion of an example GUI 500. GUI 500 depicts (with error/missing conditions) a “pick-n-choose” styled rule builder for general & complete boolean logic composition. GUI 500 can include table 415 of FIG. 4. GUI 500 can include a menu of options 505. The menu of options 505 can include any combination of “Insert Clause,” “Toggle Editing,” “Expand All,” “Toggle Expanded,” “Delete,” “Group,” “Ungroup,” and/or any other suitable menu options. The “Insert Clause” menu option can add a row, which is a row, which represents a named Boolean expression involving an Operator 515 (AND or OR) to relate it to other rows, a Field 550, a Constraint Operator 555 to compare the Field 550 to a Value 560, and the Unit 565 of the Value 560. The “Toggle Editing” menu option can put the selected row into edit mode or can take it out of edit mode. In some embodiments, to make changes to the row it may be required to be in edit mode. The “Expand All” menu option can open (expand) all groups. Groups are like folders, which are like parentheses in mathematical expressions. They indicate precedence of operations, just like in mathematical expressions. The “Toggle Expanded” menu option can open or close the selected group. This can perform the same function as, for example selecting the little + or − in front of the folder. The “Delete” menu option can delete the selected row or group if the row is a group. The “Ungroup” menu option can move the items inside a group out one level and remove the (now empty) group.

Optionally, the GUI 500 can include a test menu selection drop-down menu 510. In some examples, the selected test menu can define the fields available within the GUI 500. The selected test menu can evolve over time. In some examples, the GUI 500 can use the most recent test menu by default. If a user would like to use a different test menu, the user can, for example, select a different test menu from the test menu selection drop-down menu 510.

Optionally, the GUI 500 can include a table 515 as shown in FIG. 5. The table 515 can include multiple columns 540, 545, 550, 555, 560, 565. Each column can have an associated heading. In some examples, the headings can be user customizable. For example, a user can provide input configured to cause the GUI 500 to change the heading of the column “Name” 540 to “Geriatric”. In some examples, the table 515 can include a column for a Name 540 or description, an Operator 545, a Field 550, a Constraint Operator 555, a Value 560, and/or a Unit 565. A row in table 515 can represent a logical (e.g., Boolean) expression involving an “Operator” 545 (e.g., AND or OR) to relate it to other rows, a “Field” 550, a “Constraint Operator” 555 to compare the “Field” 550 to a “Value,” 560 and the “Unit” 565 of the “Value.”

The “Name” column 540 can be an optional field that can be used to clarify what the row is for. For instance, if the rule were Demographics.Age>75 the user might name the row “Geriatric”. The “Operator” column 545 can be a logical operator for combining the rows. For example, AND or OR can be operators. The “Field” column 550 can be the field to use in the expression. The fields options can come from the test menu and the database. Example fields can be Microscopy, Demographics, and Specimen. Subfields can also be selected, such as, for example, demographics.age—meaning the age of the patient from which the test sample was collected. The “Constraint Operator” column 555 can include <, >, <=, >=, =, Is Normal, Is Abnormal, or in very special circumstance Found In. The “Value” column 560 can be the value to compare the “Field” column 550 value to using the “Constraint Operator” column 555 value. The type of the “Value” depends on the type of the “Field” (they can be the same type). The “Unit” column 565 can be the unit of measure for the “Value.”

Optionally, the GUI 500 can include drop-down menus 520, 525, 530, and 535 within a column. The drop-down menu 525 can be, for example, in the “Field” column 550, as shown in FIG. 5. As another example, the drop-down menu 530 can be in the “Constraint Operator” column 555. Optionally, drop-down menu 520 can be in the “operation column 545 and drop-down menu 555 can be in the “Value” column 560. Drop-down menus 520, 525, 530, or 535 can be in any column, and there can be any number of drop-down menus 520, 525, 530, and 535. A drop-down menu 525 in the “Field” column 550 can include selectable options for classifications of the test sample, such as Microscopy, Chemistry, Identification, Demographics, and/or Specimen. In some examples, Microscopy and Chemistry can be defined by the selected test menu and changeable over time. Identification can include one or more identifiers (e.g., from a database), such as a barcode, rack, position, a timestamp when the system read a barcode, a name of an operator logged onto an instrument when the system read the barcode, a timestamp of a last modification of results, a name of an operator who last modified the results, or any combination of these. Demographics can include demographic information (e.g., from a database), such as an age, birth date, a date and/or time a specimen was drawn, a patient identification, an ethnicity, a diagnostic code, a first name, a middle name, a last name, a gender, or any combination of these. Specimen can include specimen information (e.g., from a database), such as a clinical operator, whether the specimen is released, whether the specimen is completed, whether the specimen is corrected, or any combination of these. In some examples, a specimen can be or can include another query, such that a current query can reference another query.

Optionally, the table 515 can include a “Value” column 560. The “Value” column 560 can include one or more user interface objects. For example, the “Value” column 560 can include a first user interface object (e.g., “Double”) associated with a type of the value (e.g., Boolean, Integer, Double, String, Grades) in the “Field” column 550. In some examples, if the “Value” column 560 can include a second user interface object (e.g., “Variables” positioned to the right of “Double”). The second user interface object can be selected to provide a variable that is dynamically determined when a custom rule is executed. The value can be calculated, downloaded, and the like, when the custom rule is executed. For example, in a hematology analysis, a user may want to compare a specimen's mean corpuscular volume (“MCV”) against a mean MCV for all patients. The mean MCV can be calculated when the custom rule is executed and the mean MCV can be displayed in GUI 500 as the Value in “Value” column 560.

In some examples, a user can begin building a custom rule by selecting an item (e.g., a “clause”) in the “Name” column 540 of the table 515 within the GUI 500. The user can select an operator, for example from the drop-down menu in the “Operator” column 545 of the table 515, to be performed. Examples of an operator can include AND or OR. The user can select a field on which to perform the operator from the drop-down menu 525, for example, in the “Field” column 550 of the table 515. The user can further select a constraint from a drop-down menu 535, for example, in the “Constraint Operator” column 555 of the table 515. In some examples, the user can specify a value, for example, by inputting a value into the text box 570 or selecting a value from the drop-down menu 535, for example, within the “Value” column 560 of the table 515. In some examples, one or more of the drop-down menus 520, 525, 530, and 535 of the GUI 500 can be dynamically populated.

Test menus on the system can be configured as desired. For example, it is possible to have results that are produced under a first test menu and other results that are produced under a second test menu simultaneously. By default the tool can use the most recent test menu, according to some embodiments. The test menu can define the fields (i.e., columns) available in table 515. For instance, the second test menu can be the same as the first test menu except for the addition of a new test parameter. If it is desired to create a query to use against an older test menu, it can be selected from the test menu selection drop-down 510.

Within the “Field” column 550, many selection options can be available based on the selected test menu. For example, microscopy can be an option. Microscopy can be defined by the test menu. Microscopy can be the list of test parameters (e.g., WBC, RBC, etc.) in the test menu. The microscopy options can change over time. The chemistry option can be defined by the selected test menu. The chemistry option can be the list of test parameters (e.g., WBC, RBC, etc.) in the test menu. The chemistry option can change over time. The identification option can be selected from the database. As such, the identification options selections are fixed. Example identification options include: Barcode (the specimen barcode label); Rack (the rack ID of the rack the specimen was run in); Position (the position of the specimen tube in the rack); Created At (the timestamp at the time the system read the barcode); Created By (the name of the operator logged on to the instrument when the system read the barcode); Modified At (time of last modification of results, i.e., editing); and Modified By (the name of the operator who last modified the results). The demographics option can be selected from the database. As such, the demographics options selections are fixed. Example demographic selection options include Age; Birth Date Time; Specimen Drawn Date Time; Patient ID; Ethnicity; Diagnostic Code; First Name; Middle Name; Last Name; and Gender. The specimen option can be selected from the database. As such, the specimen options selections are fixed. Example specimen options include: [SPECIMEN] (this is a special value for which the only Constraint Operator is Found In, which has all the named Queries in the drop-down for its values, allowing this query to reference another query); Clinical Operator; Is Release; Is Complete; and Is Corrected.

According to some embodiments, GUI 500 can provide various icons, including one icon which depends on the type of the Field (Boolean, Integer, Double, String, Grades) and another icon which is called Variable. Selecting the first provides an edit tool compatible with the type of the field (e.g., checkbox for Boolean, numeric entry for Integer or double, drop-down for Grades, text entry for String). Optionally, a test menu can define a test parameter to have Grades (e.g., bacteria in urine is often graded None, Few, Occasional, or Many instead of quantitated). In such cases, a drop-down menu can show the possible grades.

Optionally, a row can define a query in which a comparison of the field to a fixed value. In the Variable case a variable can be referenced whose value can be calculated or downloaded at the time the query is executed. For example, in hematology it may be desirable to compare a specimen's MCV against the mean MCV for all patient runs.

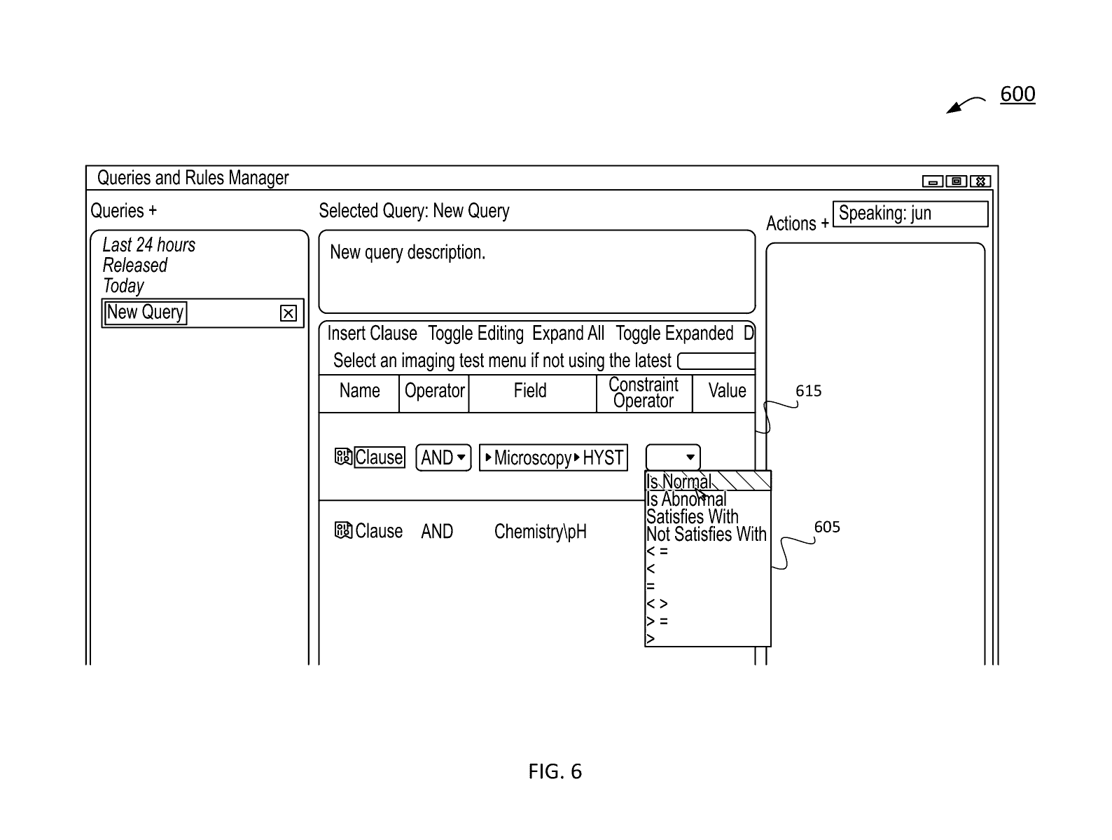

FIG. 6 displays an example GUI 600. GUI 600 can include a table 615, which can be table 515 of FIG. 5. As shown in GUI 600, a user can select one of multiple options from a drop-down menu 605, such as greater than “>,” less than “<,” greater than or equal to “>=,” less than or equal to “<=,” equal to “=,” “Is Normal”, “Is Abnormal”, or “Found In” for selection of the value used in the “constraint Operator” column for the row being edited.

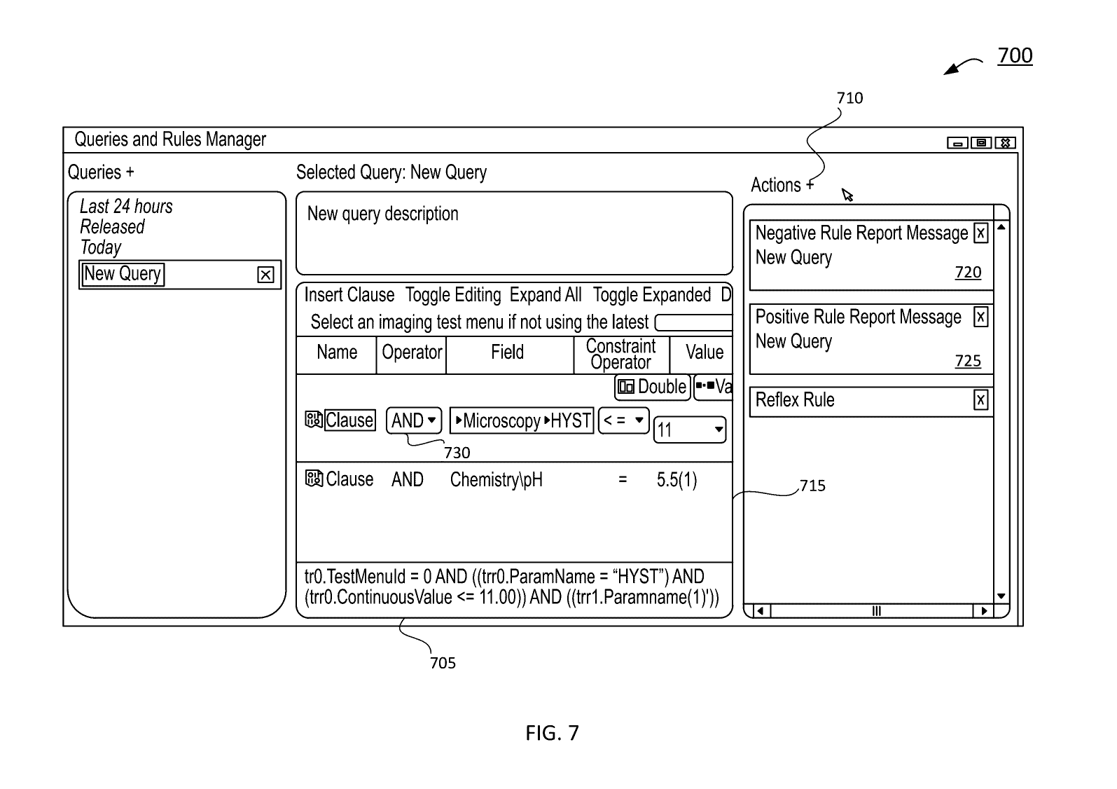

FIG. 7 displays an example GUI 700. GUI 700 can include a table 715, which can be table 515 of FIG. 5. In some examples, the GUI 700 can output and/or update in real time a custom rule, in response to a user manipulating one or more graphical user interface objects. For example, as the user selects various options from drop-down menus 730 and/or inputs data into the GUI to build a custom rule, the custom rule display 705 can build or depict the associated custom rule. In some examples, the custom rule can be in the form of one or more logical expressions. In other examples, the custom rule can be provided in one or more programming languages, such as C, C#, C++, javascript, and the like. The content of the custom rule can be customizable by a user.

Optionally, the custom rule can be executed. The custom rule can be executed by a processor, for example processor 202 of FIG. 2. The processor can determine whether one or more parameters of the rule are met or are not met. In some examples, the user can customize an action the user would like the system to take in response to obtaining no results and/or one or more results. For example, a user can select an action from a pull-down menu under the “Actions” panel 710. In some examples, the user can select a negative rule review message, which can cause the GUI 700 to output a negative message 720 to the user in response to determining that one or more parameters of the custom rule were not met. The user can additionally or alternatively select a positive rule review message, which can cause the GUI 700 to output a positive message 725 to the user in response to determining that one or more parameters of the custom rule were met. The GUI 700 can output any number or configuration of messages and/or reports in response to any number or configuration of events.

In some examples, the system and/or GUI 700 can allow the user to perform one or more other actions. Examples of actions include:

| | |
|---|---|
| Defining Queries | Queries can be defined with the following criteria to choose from: |
| | Demographics |
| | Specimen Identification |
| | Results (including ability to reference test menu settings) |
| | Various overall test status (Complete, Corrected, |
| | Created/Modified Date-Time, Create/Modified By) |
| | Composition with other rules (up to one level deep). |
| Storing Queries | The user can store queries for later reuse. Stored queries can have |
| | a Name and Description. |
| Searching by Query | Searching for specimens that satisfy a query can be capable of |
| | being performed with either queries defined on the fly or stored |
| | queries. |
| Built-in Queries | The system can offer whatever built-in queries to which the user |
| | site is entitled (i.e., has purchased). Built-in queries may not be |
| | editable and the constituents of the built-in queries may not be |
| | disclosed to the user. The Name and Description of built-in |
| | queries can be localized. |
| Rules | Queries can be combined with Actions to become Rules. This can |
| | be done with either user queries or built-in queries. |
| Validation Rules | When a specimen meets the criteria defined by the Query |
| | associated with a Validation Rule, auto-release can be prevented |
| | for the specimen, and when the operator reviews the specimen a |
| | rule-defined message can be displayed. The Validation Rule can |
| | be applied when the results are complete and the system is |
| | attempting to auto-release the results. |
| Negative Review Rules | When a specimen fails to meet the criteria defined by the Query |
| | associated with a Negative Review Rule, a rule-defined message |
| | can be displayed to the operator when the specimen is reviewed. |
| | The Negative Review Rule can be applied every time the |
| | Verification Manager screen is entered, including after editing a |
| | specimen. |
| Positive Review Rules | When a specimen meets the criteria defined by the Query |
| | associated with a Positive Review Rule, a rule-defined message |
| | can be displayed to the operator when the specimen is reviewed. |
| | The Positive Review Rule can be applied every time the |
| | Verification Manager screen is entered, including after editing a |
| | specimen. |
| Negative Report Rules | When a specimen fails to meet the criteria defined by the Query |
| | associated with a Negative Report Rule, a rule-defined message |
| | can be included in the report. The Negative Report Rule can be |
| | applied when a report is created. |
| Positive Report Rules | When a specimen meets the criteria defined by the Query |
| | associated with a Positive Report Rule, a rule-defined message |
| | can be included in the report. The Positive Report Rule can be |
| | applied when a report is created. |
| Negative LIS Rules | When a specimen fails to meet the criteria defined by the Query |
| | associated with a Negative library information service (“LIS”) |
| | Rule, a rule-defined message can be included in the transmission. |
| | The Negative LIS Rule can be applied when an LIS transmission |
| | is created. |
| Positive LIS Rules | When a specimen meets the criteria defined by the Query |
| | associated with a Positive LIS Rule, a rule-defined message can |
| | be included in the transmission. The Positive LIS Rule can be |
| | applied when an LIS transmission is created. |
| Reflex rules | Reflex rules can be configurable, where a rule can include a |
| | Boolean expression, for example associated with urine chemistry |
| | and/or demographics results, to determine whether or not to run |
| | urine microscopy. In some examples, such as Hematology, the |
| | Reflex rules can define another Hematology test menu to execute. |

Optionally, the system can automatically execute one or more custom rules in response to receive a particular type of data and/or data from a particular source. For example, the system can automatically execute a custom rule in response to receiving a particle analyzer test result from a particle analyzer. In another example, the system can execute one or more custom rules in response to user input. For example, the system can execute one or more custom rules in response to a user selecting a GUI button or changing a parameter of a customizable field within the GUI (e.g., drop-down menu 730). In some examples, the results of the executing of the one or more customizable rules can be provided to a user with the GUI, for example, in the form of a report. The user can review the report and potentially take action based on data within the report.

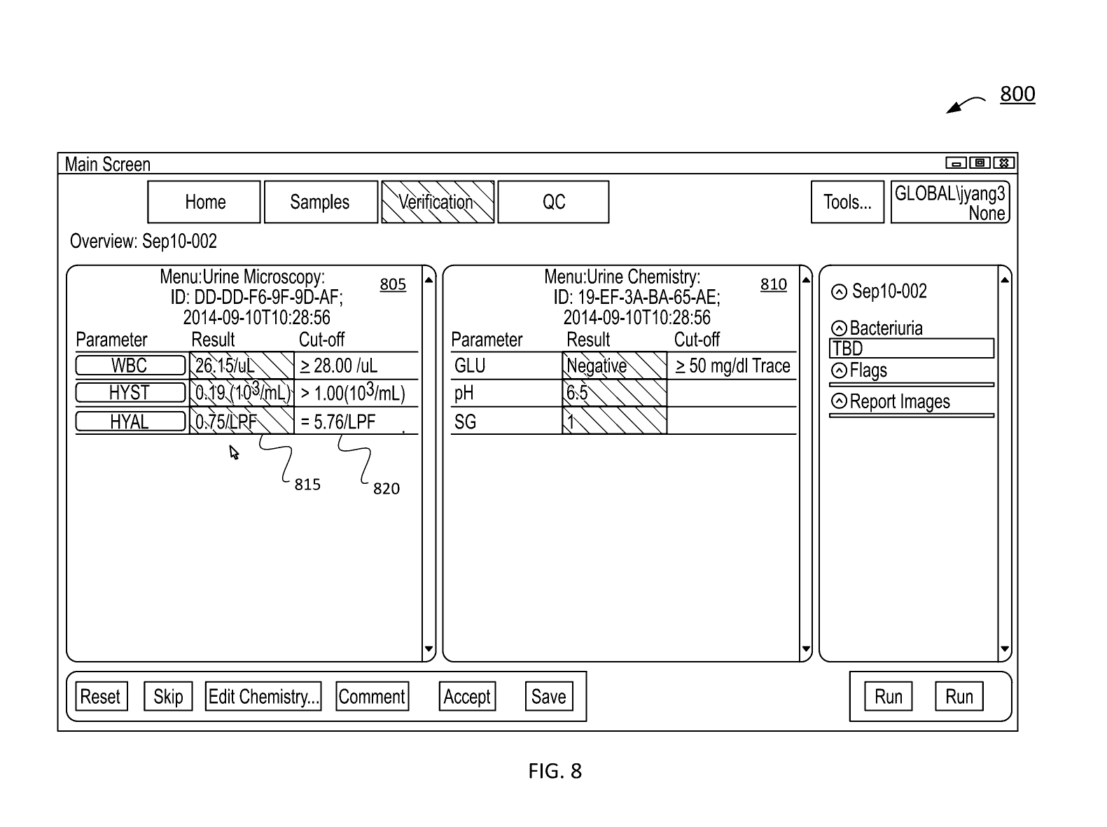

FIG. 8 depicts another example GUI 800. In some examples, the GUI 800 can provide information associated with one or more medical tests to a user. For example, the GUI 800 can provide information associated with a urine microscopy test 805 and/or urine chemistry test 810. The GUI 800 can additionally provide information associated sub-test results or parameters and their respective results and cut-off range. For example the GUI 800 can provide a result 815 and cut-off range 820 for an HYAL sub-test associated with urine microscopy test 805. In some examples, a user can customize various other aspects of the GUI 800 and/or data provided by the GUI 800.

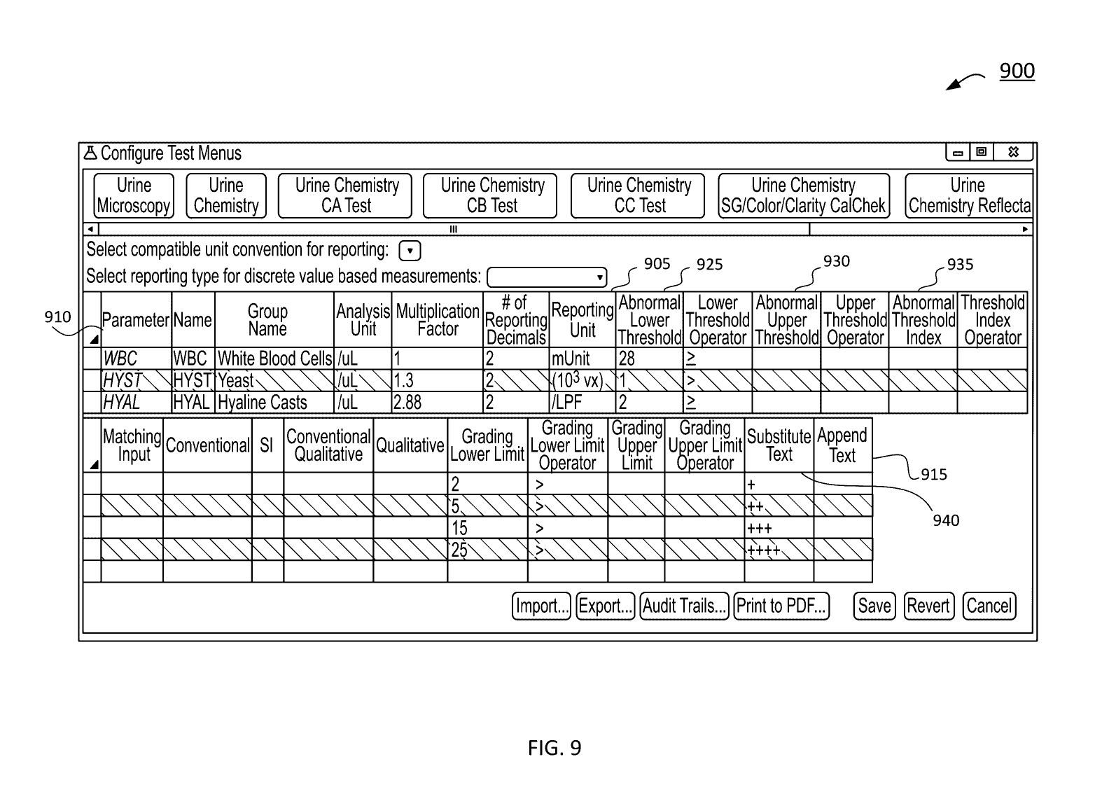

FIG. 9 depicts another example GUI 900. GUI 900 can be used to configure test menus. The user can customize a metric unit or other unit for which the GUI 900 provides data by selecting or inputting a unit into the “Reporting Unit” column 905 of the GUI 900. In one example, a particle analyzer can provide data using one unit, such as in microliters. But a user may wish to view the data using another unit, such as milliliters. The user can, for example, select the milliliter unit from a drop-down menu within the “Reporting Unit” column 905 of the GUI 900. The GUI 900 can responsively convert all data to the desired unit and provide the converted data to the user.

GUI 900 can provide a test menu configuration component that can manage mapping entries for all test parameters between raw results in analysis unit to a user customizable reporting unit. GUI 900 depicts an example of a test menu manager with a HYST test parameter selected at row 910. The selected HYST parameter at row 910 can show abnormal criteria and reporting settings in table 915.

FIG. 9 depicts aspects of a test menu according to embodiments of the present invention, which may encompass certain unit conversion techniques. As shown here, a general test menuing system can provide two-way mapping between instrument's analysis units and end-user's reporting units. For example, the display can implement user customized mapping with 1.3 multiplication factor to reporting unit of (10̂3 vx) as shown in row 910. For each parameter 920, the user can define abnormal threshold values at 925, 930, and 935. The rule builder can retrieve and display information accordingly. Optionally, the user may primarily be concerned to know whether the results of the test sample are normal or abnormal, with less emphasis on more specific details, and the display can provide a convenient depiction of the normal/abnormal status. Hence, if the user wishes to operate in terms or normal/abnormal, the display can provide that functionality. Optionally, if the user wishes to operate in terms of more detailed information, the display can provide that functionally as well (e.g., a very specific concentration, such as 6.5 per uL). In some cases, the display can output or present raw data, analysis units, and the like. The user can select the desired conversion output.

As shown in table 915, in the reporting domain, the user can classify for example discrete categories, using limits. If the user does not wish to see the numbers, the display can be configured to certain text, such as substitute text in the “Substitute Text” column 940. For example a range from 1 to 10 where 1 is undesirable and 10 is desirable. In some cases, symbols can be used (e.g. +'s, *'s, and the like). Such symbols can annotate “few, occasional, many” or other quantities or qualities.

In some examples, given that the end user can deal with sample results in their customized and/or selected reporting units, and that the entity model can store sample results in raw analysis units, the query builder can apply a reverse mapping, for example, from reporting units back to raw analysis unit, before executing the actual query.

In some examples, the system can include its own defined language, which can be a type of Domain Specific Language (“DSL”). The DSL itself can define acceptable data types (e.g., Boolean, string, Date Time, double, integer) and how the searching criteria can be constructed via its defined grammar. In some examples, a specific paragraph compliant to this DSL can be rendered (with different transformation respectively) in the following three ways for their respective usage:

1. Provide a high level description of the query itself in a text format;

2. Provide query as source code that can be compiled and executed for use in a memory object context (can be useful for users to get real-time feedback while editing results, such as particle manual reclassification with microscopy image patches);

3. Provide query as Entity SQL script that can be executed in a SQL server context (can be used for searching large samples meeting particular criteria).

In some examples, the GUI can “glue” together the entity model, test menu, and DSL. Current GUI design approaches for a general Boolean logic based searching GUIs are traditionally list view oriented, text display oriented, or tree view oriented GUI controls. The following pros and cons apply to each approach:

| Approach | Pros | Cons |
|---|---|---|
| List view oriented | Simple and straight | Complex grouping will |
| | forward for relatively | make line drawings hard |
| | simple query | to trace |
| | | Each line of criteria |
| | | could be at different |
| | | level of abstraction since |
| | | the grouping implied by |
| | | lines is not collapsible. |
| Text display | Keyboard friendly | Not intuitive and easy to |
| oriented | | make mistake |
| | | Need to know a set of |
| | | magic keywords, and |
| | | syntax grammar |
| Tree view oriented | Collapsible grouping | Text/field not aligned |
| | makes the query easy to | due to grouping level |
| | comprehend | difference |

In the GUIs 400-900 of the present disclosure, the merits of list view and tree view can be combined to use the mixture of both. An example of such a mixture is called TreeListView control.

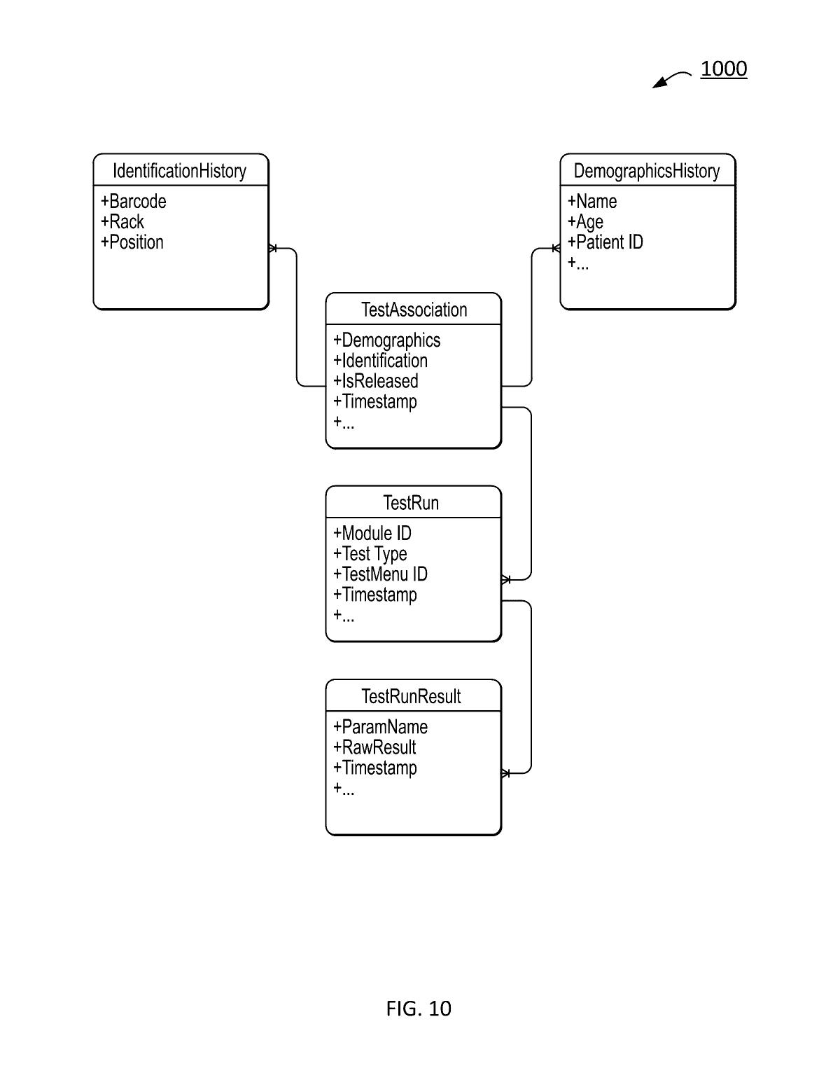

One feature of the system (e.g., system 300 of FIG. 3) can include medical sample results management. Sample results can come from different types of particle analyzers (e.g. Microscopy, Chemistry, and the like), or from different particle analyzer instances of the same type. Sample results can be linked to a specific patient and/or a specific sample identifier. Sample results can be edited and/or tracked. FIG. 10 depicts an example of an entity relationship diagram 1000 of key entity types usable by a system of the present disclosure.

Each of the specific test results for a particular test parameter can be keyed to the test parameter as defined in the associated test menus.

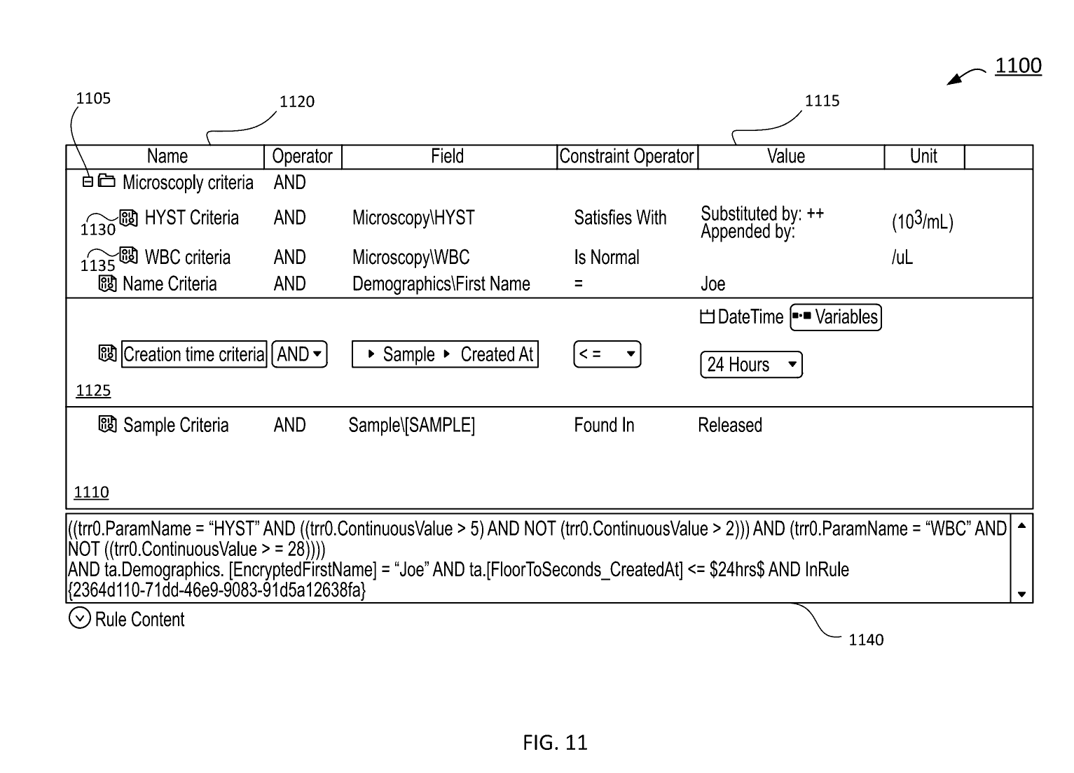

FIG. 11 is an example of a GUI 1100 implementing a TreeListView control, loaded with a query. GUI 1100 can be a portion of GUI 500 of FIG. 5 including table 515 of FIG. 5. GUI 1100 depicts a TreeListView type control that can allow groups to collapse and expand while keeping fields and/or columns aligned (e.g., as in list view). For example, the collapse button 1105 is displayed to indicate that the group can be collapsed. GUI 1100 can use reference other queries while building a new query. For example, row 1110 named “Sample Criteria,” refers to another query called “Released” in the “Value” column 1115 of the table. GUI 1100 can include fields that can be dynamically populated using a corresponding test menu. For example, values for the “Name” column 1120 such as the HYST 1130 and WBC 1135 criteria can be retrieved from the selected test menu. GUI 1100 can include support for external variables (e.g., row 1125 having a “Value” of “24 Hours” selected) which are sensitive to when the query is executed. For example, the $24 hrs$ variable can refer to the current 24 hour time range for the particular time stamp when the query is executed. GUI 1100 can include support for reverse mapping. For example, HYST 1130 and WBC 1135 criteria can reverse map the units selected for the query execution. Optionally, the user may only need to think in reporting units/domain while building the query, and the rule engine can build the actual query using an associated test menu. For example, Rule Content expandable region 1140, shows that the actual number of 28 was used for WBC criteria 1135.

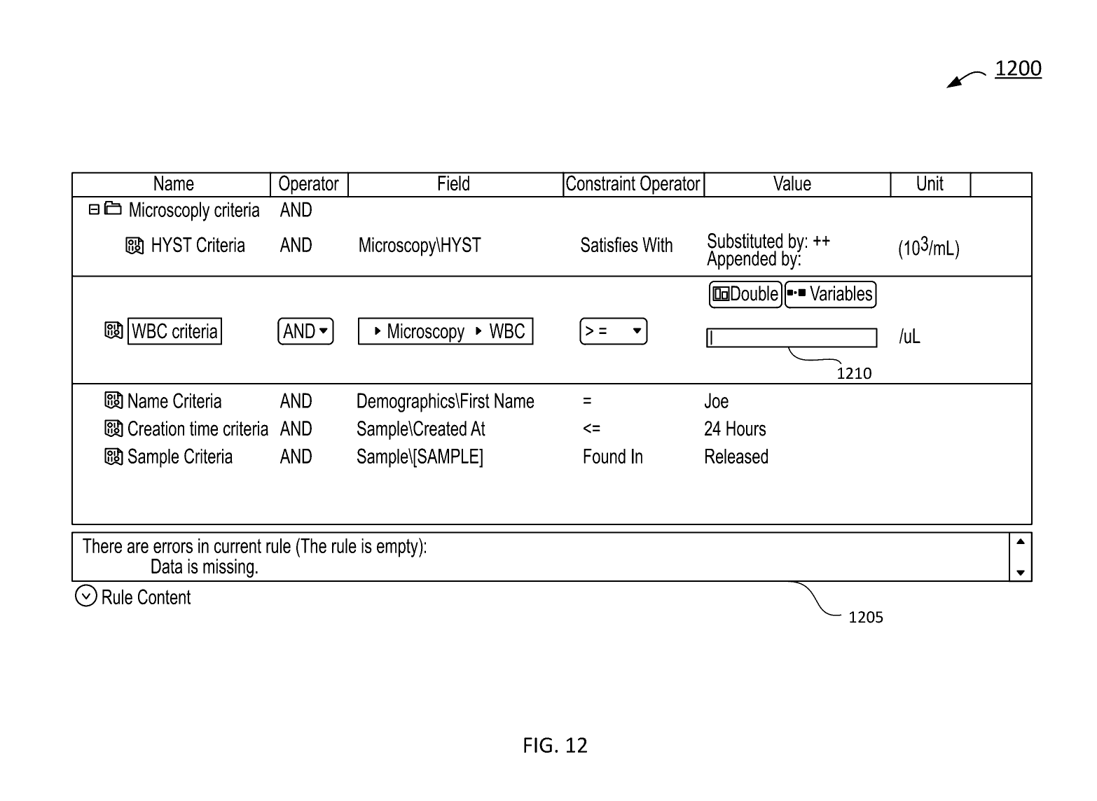

Optionally, as shown in FIG. 12, when the query input by the user has an error, GUI 1200 can highlight an area associated with the error for the user to complete or fix. For example, Rule content expandable region 1205 can show that there is an error and describe the error. The error location 1210 can be highlighted and/or the cursor can be moved to the error location 1210.

In some examples, a system of the present disclosure (e.g., system 300 of FIG. 3) can implement DSL. DSL transformation can include code/script generation for different contexts. For querying a database, the system can generate, for example, an Entity SQL script.

In some examples, for querying an in-memory objects, the system (e.g., system 300 of FIG. 3) can generate, compile, and/or execute C code, C++ code, C# code, and/or code in other programming languages on the fly. In some examples, the system can use Microsoft™ CodeDOM™ to generate the code.

In DSL transformation stages, there can be three rendering contexts—ForDsl, ForSqlContext, and ForInMemory—for a text string which is compliant with the custom DSL. The custom GUI control can first generate the most native format text string in the ForDsl context from the text string. Then at the searching rule modeling level (e.g., rather than the language level, such as the DSL itself) the system can apply context specific transformations to handle various target output requirements. For example, the system can use && to represent the AND operator in the ForInMemory context, ‘!’ to represent the NOT operator in the ForInMemory context, special processing for case insensitive string comparison requirements in the ForInMemory context, and DateTime related special processing for an Entity SQL based query context.

The system can include a RulesApplier module, which can be responsible for another level of DSL transformation. In some examples, the RulesApplier can deal with built-in variables, such as $24 hrs$, $Today$, derived fields (e.g., such as ‘[Age]’), encrypted strings, and/or DateTime based fields. In some examples, the RulesApplier can deal with a one-to-many relationship among entity types, such as TestRun and TestRunResult, and dynamic TestRunResult querying based on an associated ParamName field. The one-to-many complexity can arise from a regulatory traceability requirement. A querying requirement can be for querying the latest result set. And the dynamic targeting of TestRunResult can arise from a need to support dynamic test menu content.

In some examples, the system can generate a GUI (e.g., GUI 400 of FIG. 4) based on knowledge of the system's current test menus. The system can therefore populate portions of the GUI with dynamic test menu configurations, which can include a list of test menu Ids for Microscopy test, a list of test parameters for a given test menu, a customized reporting unit, and/or abnormal criteria and report grading output settings. The system can use a .NET reflection API and/or given knowledge of an internally defined IBaseEntity interface to dynamically populate the list of query-able entity fields with known a target data type (e.g., an integer, float, text string, Boolean DateTime, and the like)

In some examples, the system can map from users' reporting domain unit back to instrument's raw analysis unit by applying an inverse of the multiplication factor and/or using a reverse look-up in the look up table of reporting grading entries. This can allow the system to provide a user with an ease-of-use constraint operator, such as: “Is Abnormal”, “Is Normal”, “Satisfies With”, and “Not Satisfies With.”

The GUI control for the query builder can adopt the industry standard of Mode-View-ViewModel (MVVM) for creating a custom user control in Windows Presentation Foundation (WPF). The overall view model component can contain a so-called builder configurations object, which can capture test menu information and further construct the test menu reverse mappings, list of query-able targets (e.g., including those from the selected test menu, demographics, identification or other related attributes on the entity model itself), and the recursive data structure, RuleLineItem (e.g., a ViewModel type) to support arbitrary user groupings of each specified line of constraints. Within each RuleLineItem, it can define a view model to support target field selection, and a view model to support target value editing/selection.

On the construction side of the GUI itself, the system can include an the overall WPF user control for the query builder itself, which can build on top of the TreeList control. For each column based line item, a UI element can first be composed of a TargetFieldPicker user control, which can take advantage of an off-the-shelf BreadcrumbBar control, and followed by a custom user control built internally from scratch (e.g., the TargetValueEditor control). The custom user control can allow easy entering of data for all allowed data types, such as: Boolean, string, integer, double, DateTime, and/or some index for entry in a specified collection (e.g., grading mappings, external variables, reference-able queries, and the like).

At each GUI user control level, data validation (and associated GUI cues for invalid data) can be performed via implementing an IDataErrorInfo interface. Such a context sensitive data validation framework can provide users with self-guided help, thereby allowing them to use the query builder GUI (e.g., GUI 400 of FIG. 4) without much user training, if any.

Additional aspects of the systems, devices, and methods include facilitating the display and/or determination of whether a biological sample (e.g., a urine or blood sample) is normal or abnormal. Such aspects can also assist a user in analyzing or categorizing test data. In some cases, such aspects can allow results to be automatically routed to doctors and/or hospitals if the results are normal, and/or to prompt an operator or user to rerun samples or conduct more analysis if the results are abnormal.

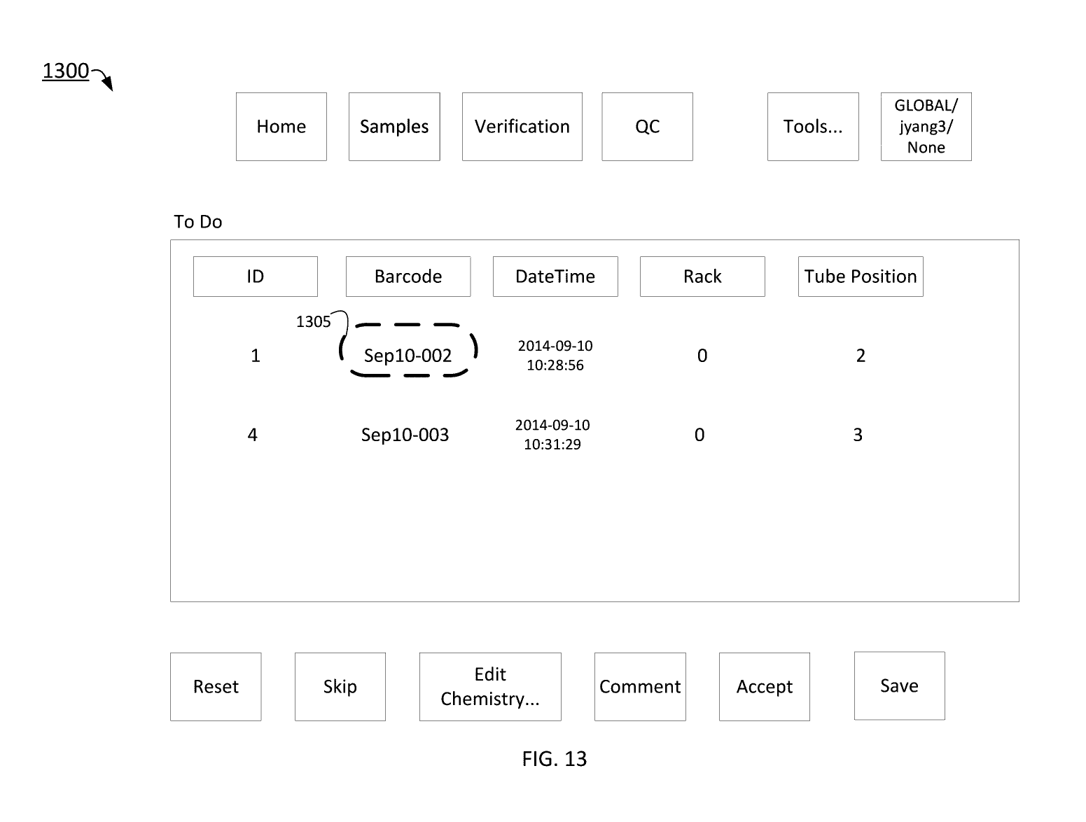

FIG. 13 depicts features of a work list 1300 according to embodiments of the present invention. In some cases, it is possible to select (e.g., double click) a certain field or button, to obtain related information, for each particular specimen on the work list 1300. For example, as shown in FIG. 13, it is possible to select the Sep10-002 button 1305.

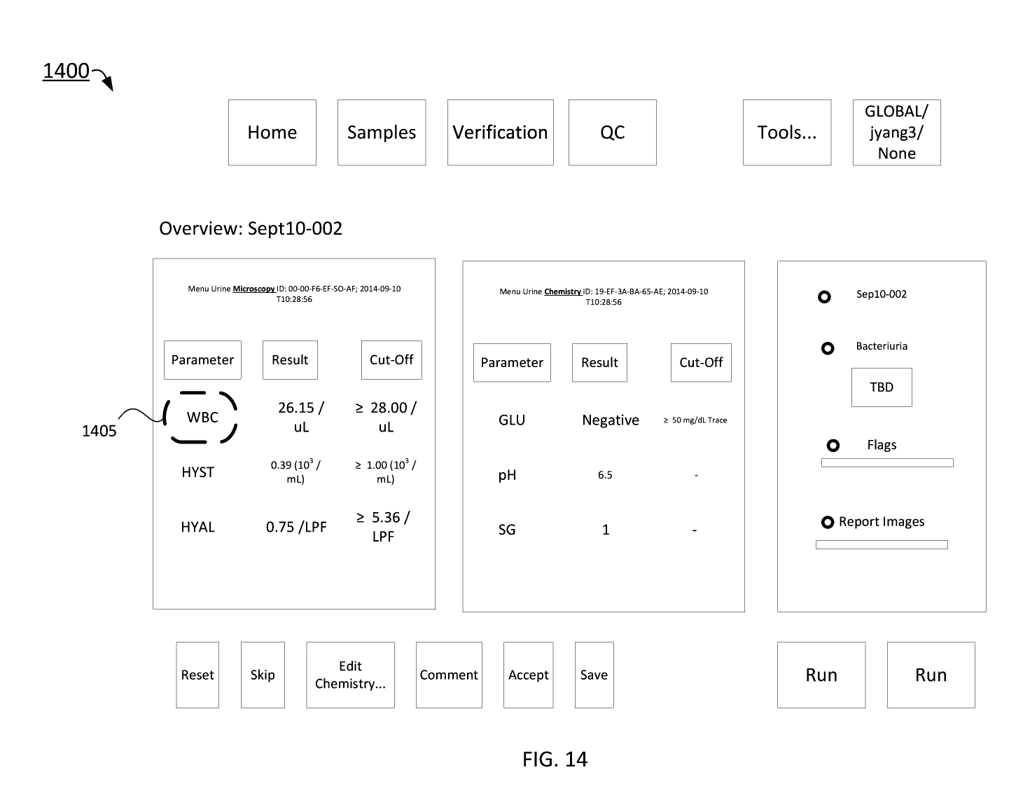

Selection of button 1305 can result in GUI 1400 as shown in FIG. 14.

As illustrated in FIG. 14, microscopy and/or chemistry results can be displayed or provided. In this embodiment, urinalysis results are shown. In other embodiments, hematology results (which can include, for example, numerical results from a cell counter) may be shown.

In some cases, it is possible to select (e.g., double click) a certain field or button (e.g., corresponding to cell types, analytes, and the loke), to obtain related information. For example, it is possible to select the WBC button 1405, and as a result WBC images can be displayed.

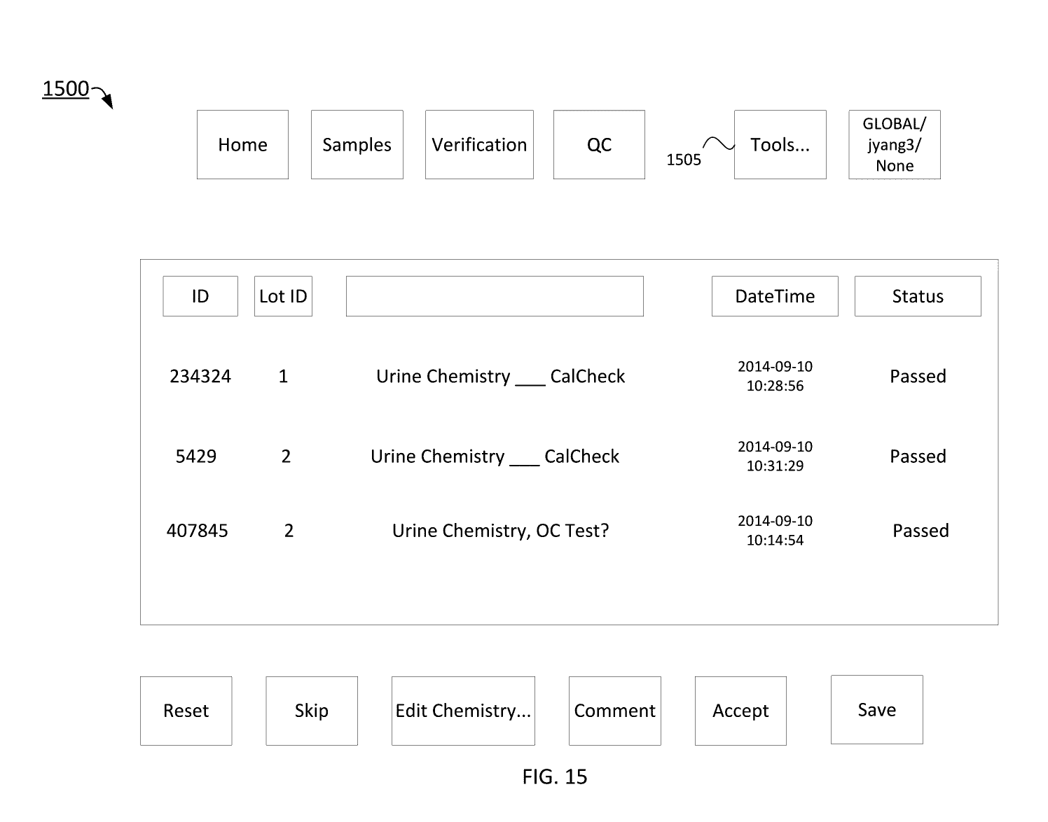

FIG. 15 depicts aspects of a Quality Control screen 1500, according to embodiments of the present invention.

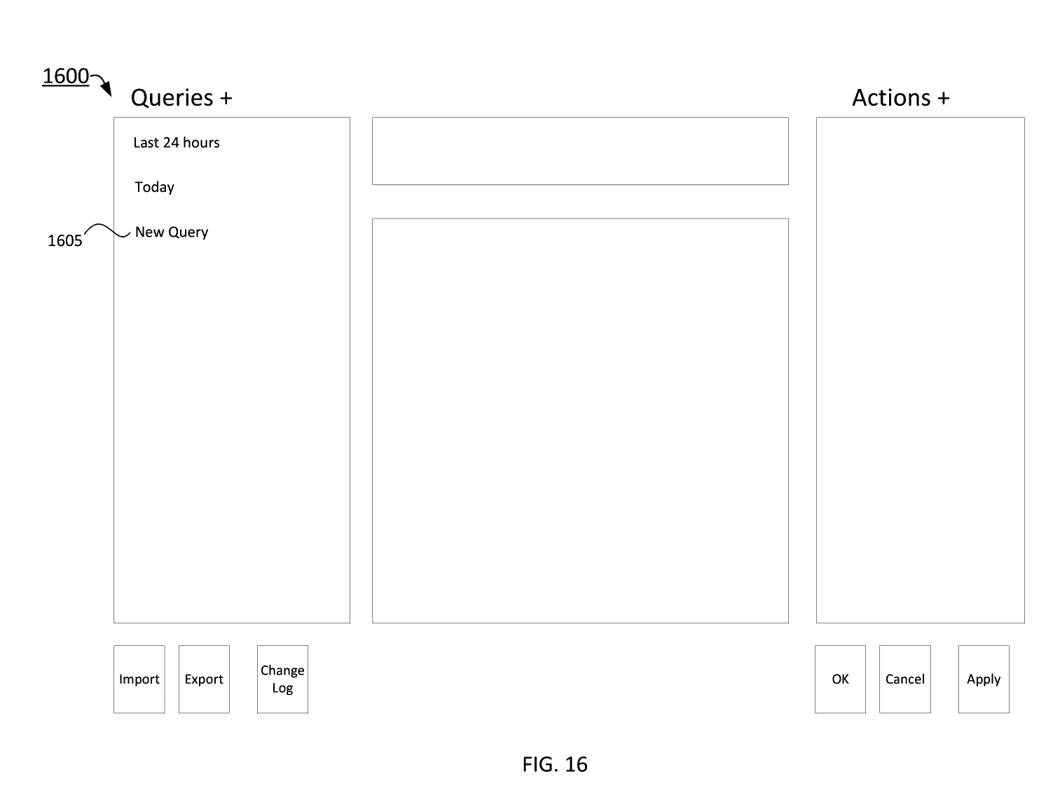

Selection of the Tools box 1505 can result in a drop down menu being displayed. The user can then select or click on a selection, for example, “Configure Queries and Rules,” and as a result the image of FIG. 16 can be displayed.

FIG. 16 depicts a GUI 1600 for configuring queries and rules. GUI 1600 can be a portion of GUI 400 of FIG. 4. Within GUI 1600, the user can then select or click on “New Query” button 1605. Upon selection of button 1605, a new query GUI can be displayed.

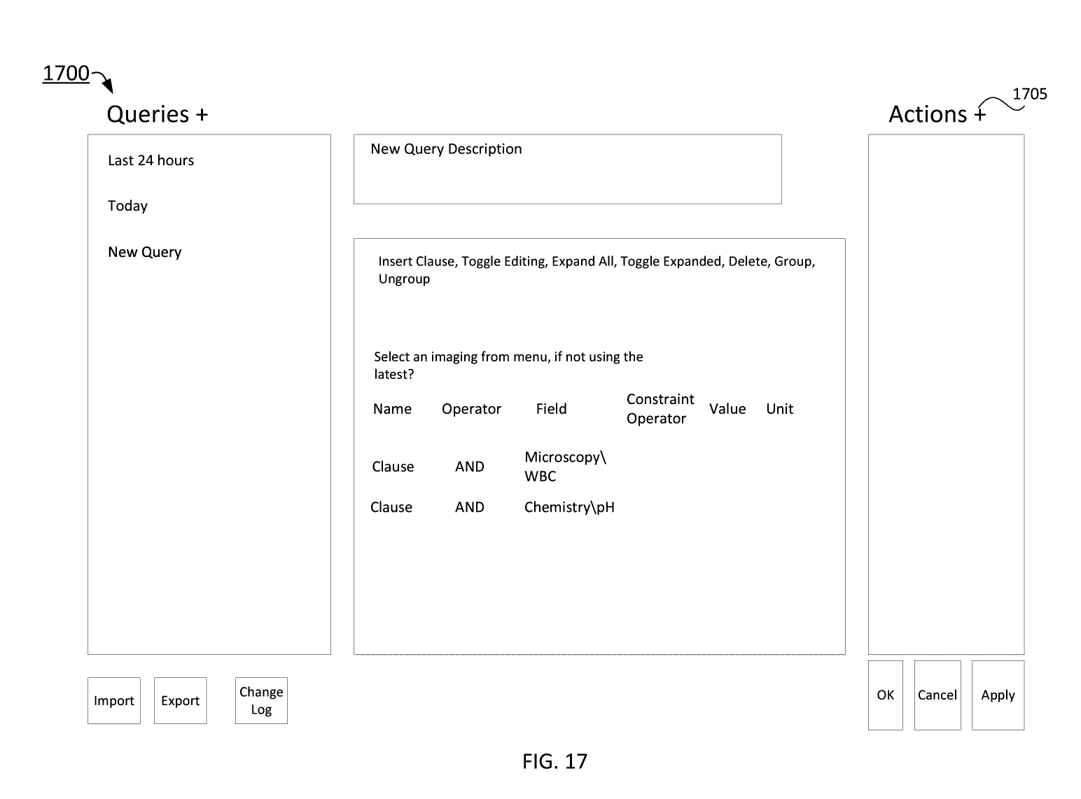

FIG. 17 depicts a new query GUI 1700. GUI 1700 can be GU 400 of FIG. 4. Using GUI 1700 a user can create queries, for example by putting together Boolean logic expressions, using build conditions, filter conditions, and the like as described with respect to FIGS. 4-7. In some cases, it is possible to use expressions to pull or retrieve from certain domains, such as patient demographics. Relatedly, microscopy results, chemistry results, and the like, may be available.

According to some embodiments, it is possible to select Actions, which in turn provides a pull down menu and/or a display of “Validation Message, new query” in box under “Actions+”. Queries can be saved, and it is possible to use them to filter data. In some embodiments, it is possible to select a Query, and add actions to it. An exemplary format can be depicted as: query+action=rule.

Optionally, the user can select from a variety of different actions, for example, from Actions+1705, which if selected can display a drop down selection menu. For example, a Negative Rule Report Message (if the rule is not matched, will add a message to the report) can be selected as described above with respect to FIG. 7. Optionally, as also described with respect to FIG. 7, a Positive Rule Review Message can be selected. In some cases, a Reflex Rule can be selected. Negative Rule Report Message (if the rule is not matched), will add a message to the report. This can be configured to include any desired message. For example, the display may prompt the user (e.g., operator or clinician) if the user would like to order a related test. Positive Rule Review Message (if the rule is matched), will add a message to the review. For example, if the user calls sperm, there is a potential legal ramification, if sperm is present in the sample. Reflex Rule (will automatically order another test). These techniques can be used to apply Rules to the results after the results are obtained, and a variety of Actions can be specified.

A Validation Message can be similar to a Review Message. The difference between the two can pertain to the point along the workflow where the rule is applied. For example, Validation Message can be applied as soon as the results are displayed. This can facilitate a determination whether to automatically release the specimen, or whether to put it on the worklist for the operator to review. In some cases, a validation method can be used to facilitate a determination whether to automatically release a specimen, or put it on worklist for the operator to review. Review Messages can be applied when the results are first obtained or inputted, and can also or optionally be applied each time the operator makes any changes to those results. For example, if the operator is looking at a specimen and observes possible sperm content, the operator can change the classification, and then edit the specimen results. If there is a rule in place concerning sperm, the system or device (e.g., display) can prompt the user to confirm whether this is the intended classification, for example due to possible legal ramifications.

In some cases, a Report Message can be added to a report, for example when results are released to a user or clinician. In some cases, a LIS message, which can be similar to a Report Message (except it goes to the LIS), can be provided. An LIS message can be different from a Report Message in that there may be messages the user wishes to send to LIS, that are actually meant for consumption by other software. Hence, the software associated with the LIS can recognize that, and can perform additional analysis or activity based on that. For example, this technique can be used to support a urinalysis technique where evidence is observed that may indicate a urinary tract infection, and if the user creates a rule to generate an LIS message about that, then in their LIS they can be looking for that output, and use that to automatically trigger a UTI bacteria culture.

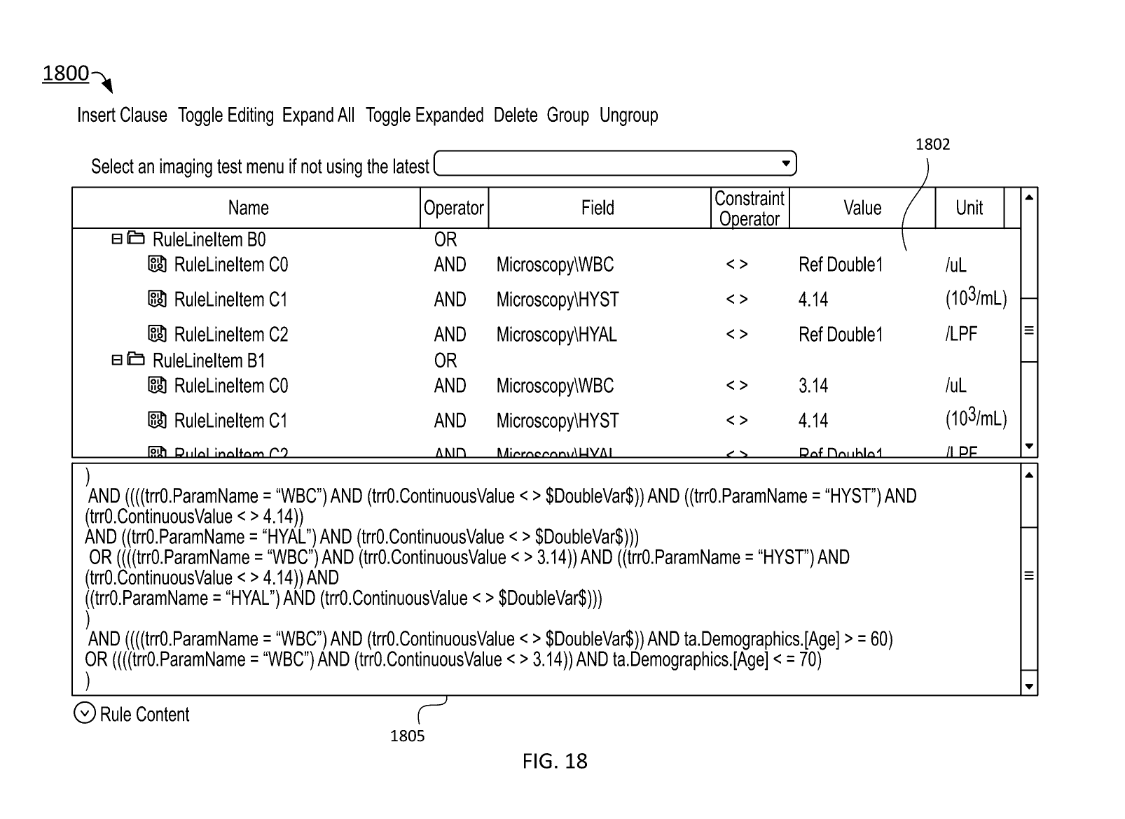

As shown in FIG. 18, when building queries using input objects of GUI portion 1802, related logic strings can be displayed in the rule content expandable area 1805. The user can select the Insert Clause, to add another row as described in detail with respect to FIG. 5. According to some embodiments, it is possible to construct queries using arbitrary, complex rules. In some embodiments, complex rules can be built directly in rule content expandable area 1805 using logical language as shown or other programming languages, such as C, C#, C++, javascript, and the like.

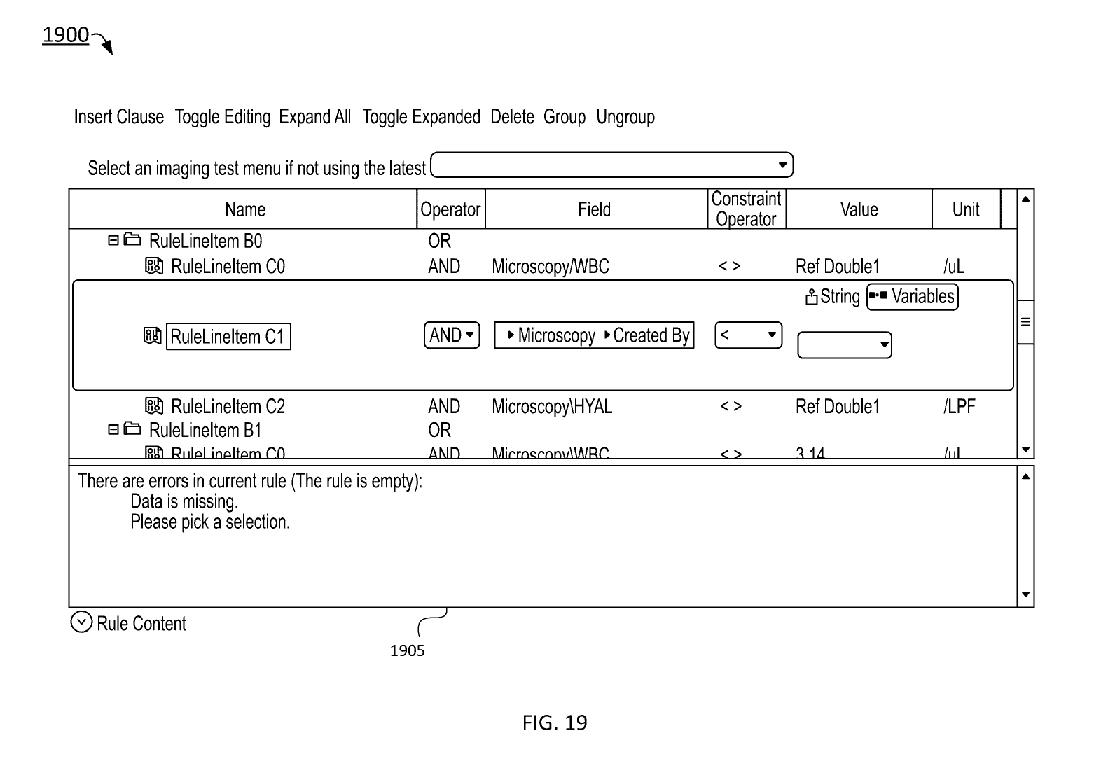

FIG. 19 provides another example GUI 1900. GUI 1900 can be another example of GUI 400 of FIG. 4. In GUI 1900, errors are highlighted in the rule content expandable area 1905. In this way, embodiments can provide an error proof way to implement Boolean logic.

According to some embodiments, it is possible to use full Boolean logic, for example to perform grouping and ungrouping selections. By making such “Group” and Ungroup” selections, it is possible to can change the structure or architecture of the query hierarchy.

The tables below depict aspects of grouping and ungrouping functionality according to embodiments of the present invention.

Query 1: RBC > 4

| Record No. | Patient Name | RBC | WBC | Age |
|---|---|---|---|---|
| 1 | Sophia | 5 | 8 | 28 |
| 2 | Noah | 4 | 6 | 34 |
| 3 | Liam | 3 | 12 | 57 |
| 4 | Emma | 6 | 3 | 41 |
| 5 | Emma | 6 | 3 | 41 |

Query 2: WBC > 4

| Record No. | Patient Name | RBC | WBC | Age |
|---|---|---|---|---|
| 1 | Sophia | 5 | 8 | 28 |
| 2 | Noah | 4 | 6 | 34 |
| 3 | Liam | 3 | 12 | 57 |
| 4 | Emma | 6 | 3 | 41 |
| 5 | Emma | 6 | 3 | 41 |

Query 3: Age > 40

| Record No. | Patient Name | RBC | WBC | Age |
|---|---|---|---|---|
| 1 | Sophia | 5 | 8 | 28 |
| 2 | Noah | 4 | 6 | 34 |
| 3 | Liam | 3 | 12 | 57 |
| 4 | Emma | 6 | 3 | 41 |
| 5 | Emma | 6 | 3 | 41 |

Boolean operators: AND has precedence over OR

### Queries 2 and 3 (Ungrouped)

### Query 1 AND Query 2 OR Query 3=>(1 AND 2) OR 3

return records 1, 3, 4, and 5

### Queries 2 and 3 (Grouped)

### Query 1 AND Query 2 OR Query 3=>1 AND (2 OR 3)

return records 1, 4, and 5

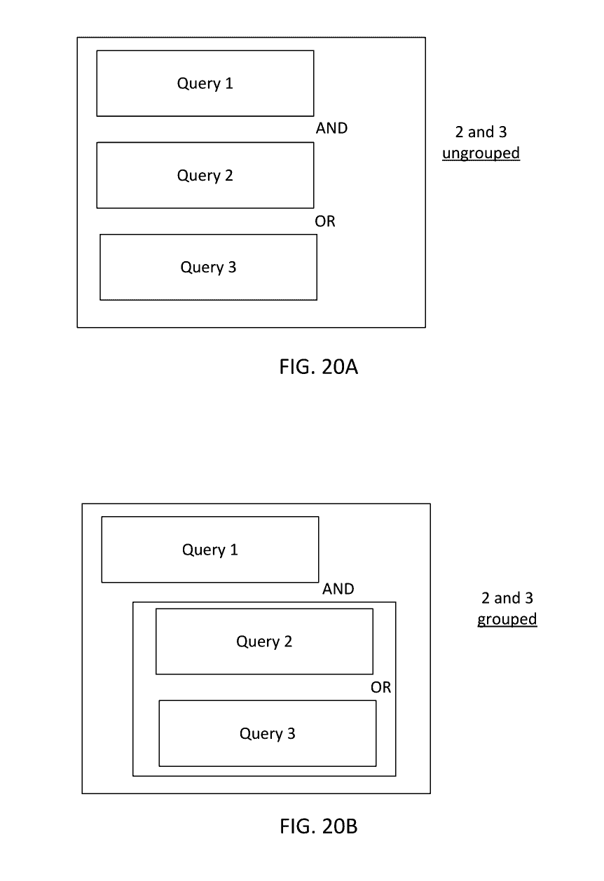

FIG. 20A depicts a first screen shot where Queries 2 and 3 are ungrouped. FIG. 20B depicts a second screen shot where Queries 2 and 3 are grouped.

For the purposes of FIGS. 20A and 20B, Query 2 can correspond to a first clinical data query and Query 3 can correspond to a second clinical data query. The Boolean Operator between Queries 2 and 3 is “OR”. Typically, the AND operator takes precedence over the OR operator as depicted in FIG. 20A. This can be the default situation. However, by toggling the precedence, the OR operator can take elevated precedence over the AND operator as depicted in FIG. 20B.

Exemplary computer systems for assigning precedence to a Boolean operator between clinical data queries using a graphical user interface (GUI) may include a display device that displays the GUI, a processor, and a tangible non-transitory computer readable medium. The computer readable medium can be programmed with a computer application that, when executed by the processor, causes the processor to display a first clinical data query on the GUI, display a second clinical data query on the GUI, display the Boolean operator on the GUI, the Boolean operator defining a relationship between the first and second clinical data queries, display a precedence indicator on the GUI, the precedence indicator signifying whether the Boolean operator has a default precedence or an elevated precedence, receive a precedence toggle from a user, in response to the toggle (i) assign the elevated precedence to the Boolean operator if the Boolean operator is at the default precedence, or (ii) assign the default precedence to the Boolean operator if the Boolean operator is at the elevated precedence, and in response to the toggle (i) change the precedence indicator to signify the elevated precedence if the indicator signifies the default precedence, or (ii) change the precedence indicator to signify the default precedence if the indicator signifies the elevated precedence.

Exemplary computer program products for allowing a user to assign precedence to a Boolean operator between clinical data queries using a graphical user interface (GUI) may include code for displaying the GUI on a display device, code for displaying a first clinical data query on the GUI, code for displaying a second clinical data query on the GUI, code for displaying the Boolean operator on the GUI, the Boolean operator defining a relationship between the first and second clinical data queries, code for displaying a precedence indicator on the GUI, the precedence indicator signifying whether the Boolean operator has a default precedence or an elevated precedence, code for receiving a precedence toggle from the user, code for assigning, in response to the toggle, (i) the elevated precedence to the Boolean operator if the Boolean operator is at the default precedence, or (ii) the default precedence to the Boolean operator if the Boolean operator is at the elevated precedence, and code for changing, in response to the toggle, (i) the precedence indicator to signify the elevated precedence if the indicator signifies the default precedence, or (ii) the precedence indicator to signify the default precedence if the indicator signifies the elevated precedence.

Exemplary computer automated methods for allowing a user to assign precedence to a Boolean operator between clinical data queries using a graphical user interface (GUI) may include displaying the GUI on a display device, displaying a first clinical data query on the GUI, displaying a second clinical data query on the GUI, displaying the Boolean operator on the GUI, the Boolean operator defining a relationship between the first and second clinical data queries, displaying a precedence indicator on the GUI, the precedence indicator signifying whether the Boolean operator has a default precedence or an elevated precedence, receiving a precedence toggle from the user, assigning, in response to the toggle, (i) the elevated precedence to the Boolean operator if the Boolean operator is at the default precedence, or (ii) the default precedence to the Boolean operator if the Boolean operator is at the elevated precedence, and changing, in response to the toggle, (i) the precedence indicator to signify the elevated precedence if the indicator signifies the default precedence, or (ii) the precedence indicator to signify the default precedence if the indicator signifies the elevated precedence.

In some embodiments, a computer system for assigning precedence to a Boolean operator between clinical data queries using a graphical user interface (GUI) may include a database configured to store test results from a particle analyzer, the database comprising a set of data. Exemplary particle analyzers can include systems or features such as those described in U.S. Patent Application Nos. 61/799,014 and 61/799,152 filed Mar. 15, 2013, U.S. patent application Ser. Nos. 14/215,834, 14/216,339, 14/216,533, 14/216,562, 14/216,811, 14/217,034, and 14/217,228 filed Mar. 17, 2014, and International Patent Application No. PCT/US14/30942 filed Mar. 18, 2014. The content of each of the above filings is incorporated herein by reference. Computer systems may also include a display device that displays the GUI, a processor, and a tangible non-transitory computer readable medium. The computer readable medium can be programmed with a computer application that, when executed by the processor, causes the processor to display a first clinical data query on the GUI, wherein the first clinical data query corresponds to a first subset of data on the database, display a second clinical data query on the GUI, wherein the second clinical data query corresponds to a first subset of data on the database, display the Boolean operator on the GUI, the Boolean operator defining a relationship between the first and second clinical data queries, display a precedence indicator on the GUI, the precedence indicator signifying whether the Boolean operator has a default precedence or an elevated precedence, receive a precedence toggle from a user, in response to the toggle (i) assign the elevated precedence to the Boolean operator if the Boolean operator is at the default precedence, or (ii) assign the default precedence to the Boolean operator if the Boolean operator is at the elevated precedence, and in response to the toggle (i) change the precedence indicator to signify the elevated precedence if the indicator signifies the default precedence, or (ii) change the precedence indicator to signify the default precedence if the indicator signifies the elevated precedence.

According to some embodiments, systems for allowing an operator to group or ungroup clinical data queries using a graphical user interface (GUI) may include a processor and a tangible non-transitory computer readable medium. The computer readable medium can be programmed with a computer application that, when executed by the processor, causes the processor to display a first clinical data query on the GUI, display a second clinical data query on the GUI, display a Boolean operator on the GUI, the Boolean operator defining a relationship between the first and second clinical data query, display a precedence indicator on the GUI, the precedence indicator signifying whether the Boolean operator has a default precedence or an elevated precedence, receive a precedence toggle from the operator, in response to the toggle (i) assign the elevated precedence to the Boolean operator if the Boolean operator is at the default precedence, or (ii) assign the default precedence to the Boolean operator if the Boolean operator is at the elevated precedence, and in response to the toggle (i) change the precedence indicator to signify the elevated precedence if the indicator signifies the default precedence, or (ii) change the precedence indicator to signify the default precedence if the indicator signifies the elevated precedence.

According to some embodiments, a system for allowing an operator to group or ungroup clinical data filtering queries using a graphical user interface may include a processor and a tangible non-transitory computer readable medium. The computer readable medium can be programmed with a computer application that, when executed by the processor, causes the processor to display a first clinical data filtering query to the operator on the graphical user interface, display a second clinical data filtering query to the operator on the graphical user interface, display a grouping classification indicator to the user on the graphical user interface, the grouping classification indicator signifying whether the first and second queries are grouped or ungrouped, receive a reclassification instruction from the operator, in response to the reclassification instruction, group the first and second clinical data filtering queries into a single expression if the first and second clinical data filtering queries are ungrouped, or ungroup the first and second clinical data filtering queries into two separate expressions if the first and second clinical data filtering queries are grouped, and in response to the reclassification instruction, change the grouping classification indicator from grouped to ungrouped or from ungrouped to grouped. Exemplary methods for allowing a user to group and ungroup clinical test result data with a graphical user interface and/or for allowing a user to filter clinical test result data with a graphical user interface may include similar features.

According to some embodiments, methods for returning multiple data sets from a database storing particle analyzer test results may include outputting, by a medical hardware apparatus for presentation by a display device, a clinical data query that returns a first set of particle analyzer test results from the database based upon a first precedence relationship between a first Boolean operator and a second Boolean operator of the clinical data query, detecting, by the medical hardware apparatus, a user command to transform the first precedence relationship between the first Boolean operator and the second Boolean operator of the clinical data query from the first precedence relationship to a second precedence relationship, transforming, by the medical hardware apparatus, the first precedence relationship between the first Boolean operator and the second Boolean operator of the clinical data query from the first precedence relationship to the second precedence relationship in response to the detected user command, and returning, by the medical hardware apparatus, a second set of particle analyzer test results from the database based upon the second precedence relationship between the first Boolean operator and the second Boolean operator of the clinical data query, in response to instantiation of the clinical data query. According to some embodiments, wherein the first Boolean operator has precedence over the second Boolean operator in the first precedence relationship, and wherein the second Boolean operator has precedence over the first Boolean operator in the second precedence relationship.

According to some embodiments, exemplary methods may include outputting, by a computer system for presentation by a display device, a clinical data query predefined to return a particular set of particle analyzer test results based upon a default precedence relationship between at least two Boolean operators of the clinical data query, detecting, by the computer system, a particular command to modify the precedence relationship between the at least two Boolean operators of the clinical data query from the default precedence relationship to another precedence relationship, and returning, by the computer system, another particular set of the particle analyzer test results based upon the another precedence relationship between the at least two Boolean operators of the clinical data query, in response to instantiation of the clinical data query.

According to some embodiments, exemplary methods for returning medical data encompassing a test result from a particle analyzer may include outputting for display, or displaying, by the medical device, a graphical user interface (GUI) having at least one input field, or object, for receiving a data query (e.g. clinical data query string) in an initial format. Methods may also include receiving, by the medical device, the data query (or clinical data query string). Further, methods may include transforming, by the medical device, the data query (or clinical data query string) into a plurality of different data queries (or query strings), wherein each of the plurality of different data queries (or query strings) includes a different format from the initial format and for use to query at least one of a plurality of different medical databases or object graphs in memory. Still further, methods may include querying, by the medical device, each of the plurality of different medical databases or object graphs in memory using a particular one of the plurality of different data queries (or query strings) based upon a type of an associated medical database, receiving, by the medical device, a plurality of data sets from the plurality of different medical databases or object graphs in memory, wherein at least one of the plurality of data sets comprises the test result from the particle analyzer and outputting for display, by the medical device, at least a portion of each of the plurality of data sets via the GUI.

According to some embodiments, exemplary medical devices for returning medical data encompassing a test result from a particle analyzer may include a processor and a memory device in which instructions executable by the processor are stored for causing the processor to output, via a display device, a graphical user interface (GUI) having at least one input field for receiving a clinical data query string in an initial format, receive, via an input device, the clinical data query string, transform the clinical data query string into a plurality of different query strings, each of the plurality of different query strings comprising a different format from the initial format and for use with at least one of a plurality of different medical databases or object graphs in memory, query each of the plurality of different medical databases or object graphs in memory using an associated one of the plurality of different query strings, receive a plurality of data sets from the plurality of different medical databases or object graphs in memory, at least one of the plurality of data sets comprising the test result from the particle analyzer, and output, via the display device, at least a portion of each of the plurality of data sets in the GUI.

According to some embodiments, a non-transient computer readable medium can include a program code, which when executed by a processor is configured to cause the processor to output, by a medical device and via a display device, a graphical user interface (GUI) comprising at least one input field for receiving a clinical data query string in an initial format, receive, by the medical device and via an input device, the clinical data query string, transform, by the medical device, the clinical data query string into a plurality of different query strings, each of the plurality of different query strings comprising a different format from the initial format and for use with at least one of a plurality of different medical databases or object graphs in memory, query, by the medical device, each of the plurality of different medical databases or object graphs in memory using an associated one of the plurality of different query strings, receive, by the medical device, a plurality of data sets from the plurality of different medical databases or object graphs in memory, at least one of the plurality of data sets comprising a test result from a particle analyzer, and output, by the medical device and via the display device, at least a portion of each of the plurality of data sets in the GUI.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

It is to be understood that the figures and descriptions of embodiments of the invention have been simplified to illustrate elements that are relevant for a clear understanding of the invention. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It can be appreciated that the examples are intended primarily for purposes of illustration of the invention for those skilled in the art. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

All patents, patent publications, patent applications, journal articles, books, technical references, and the like discussed in the instant disclosure are incorporated herein by reference in their entirety for all purposes.

What is claimed is:

1. A method for returning medical data comprising a test result from a particle analyzer, the method comprising:
receiving, by a medical device, a clinical data query in an initial format from an input object;
transforming, by the medical device, the clinical data query into a plurality of different query types, wherein each of the plurality of different query types comprises a different format from the initial format and is for use to query at least one of a plurality of different medical databases;
querying, by the medical device, each of the plurality of different medical databases using a particular one of the plurality of different query types based on a type of an associated medical database;
receiving, by the medical device, a plurality of data sets from the plurality of different medical databases, wherein at least one of the plurality of data sets comprises the test result from the particle analyzer; and
outputting for display, by the medical device, at least a portion of each of the plurality of data sets.

2. The method of claim 1, wherein the clinical data query comprises a first Boolean operator, a second Boolean operator, and a first precedence relationship between the first Boolean operator and the second Boolean operator, the method further comprising:
detecting, by the medical device, a user command to change the first precedence relationship between the first Boolean operator and the second Boolean operator of the clinical data query from the first precedence relationship to a second precedence relationship; and
changing, by the medical device, the first precedence relationship to the second precedence relationship in response to the detected user command;
querying, by the medical device, at least one of the plurality of different medical databases based on the second precedence relationship;
receiving, by the medical device, at least one data set based on querying based on the second precedence relationship; and
outputting for display, by the medical device, at least a portion of the at least one data set.

3. The method of claim 2, wherein the first Boolean operator has precedence over the second Boolean operator in the first precedence relationship and wherein the second Boolean operator has precedence over the first Boolean operator in the second precedence relationship.

4. The method of claim 1, further comprising:
causing the particle analyzer to perform a particle analysis on a medical test sample to generate the test result;
formatting the test result into a data type usable with at least one of the plurality of different medical databases; and
storing the test result in the at least one of the plurality of different medical databases.

5. The method of claim 1, further comprising:
outputting for display a graphical user interface (GUI) comprising the input object, wherein the input object comprises an input field; and
outputting for display the at least the portion of each of the plurality of data sets via the GUI.

6. The method of claim 5, further comprising:
receiving a threshold for a parameter of the test result via the GUI, wherein the test result comprises a urinalysis test result and the parameter comprises a white blood cell count or an amount of a bacteria;
determining if the parameter of the test result exceeds the threshold; and
changing a color of a GUI component or changing a location on a display device of the GUI component in response to determining that the parameter exceeds the threshold.

7. The method of claim 6, further comprising:
receiving a second threshold for a second parameter of the test result via the GUI, wherein the second parameter comprises a number of urinary casts;
determining if the second parameter exceeds the second threshold; and
modifying a characteristic of the GUI in response to determining that the second parameter exceeds the second threshold.

8. A medical device for returning medical data comprising a test result from a particle analyzer, the medical device comprising:
a processor; and
a memory device in which instructions executable by the processor are stored for causing the processor to:
receive a clinical data query in an initial format from an input object;
transform the clinical data query into a plurality of different query types, wherein each of the plurality of different query types comprises a different format from the initial format and is for use to query at least one of a plurality of different medical databases;
query each of the plurality of different medical databases using a particular one of the plurality of different query types based on a type of an associated medical database;
receive a plurality of data sets from the plurality of different medical databases, wherein at least one of the plurality of data sets comprises the test result from the particle analyzer; and
output for display at least a portion of each of the plurality of data sets.

9. The medical device of claim 8, wherein the clinical data query comprises a first Boolean operator, a second Boolean operator, and a first precedence relationship between the first Boolean operator and the second Boolean operator, the instructions further causing the processor to:
detect a user command to change the first precedence relationship between the first Boolean operator and the second Boolean operator of the clinical data query from the first precedence relationship to a second precedence relationship; and
change the first precedence relationship to the second precedence relationship in response to the detected user command;
query at least one of the plurality of different medical databases based on the second precedence relationship;
receive at least one data set based on querying based on the second precedence relationship; and
output at least a portion of the at least one data set.

10. The medical device of claim 9, wherein the first Boolean operator has precedence over the second Boolean operator in the first precedence relationship and wherein the second Boolean operator has precedence over the first Boolean operator in the second precedence relationship.

11. The medical device of claim 8, wherein the memory device further comprises instructions executable by the processor for causing the processor to:
cause the particle analyzer to perform a particle analysis on a medical test sample to generate the test result;
format the test result into a data type usable with at least one of the plurality of different medical databases; and
store the test result in the at least one of the plurality of different medical databases.

12. The medical device of claim 8, wherein the memory device further comprises instructions executable by the processor for causing the processor to:
output for display a graphical user interface (GUI) comprising the input object, wherein the input object comprises an input field; and
output for display the at least the portion of each of the plurality of data sets via the GUI.

13. The medical device of claim 12, wherein the memory device further comprises instructions executable by the processor for causing the processor to:
receive a threshold for a parameter of the test result via the GUI, wherein the test result comprises a urinalysis test result and the parameter comprises a white blood cell count or an amount of a bacteria;
determine if the parameter of the test result exceeds the threshold; and
change a color of a GUI component or change a location on a display device of the GUI component in response to determining that the parameter exceeds the threshold.

14. The medical device of claim 13, wherein the memory device further comprises instructions executable by the processor for causing the processor to:
receive a second threshold for a second parameter of the test result via the GUI, wherein the second parameter comprises a number of urinary casts;
determine if the second parameter exceeds the second threshold; and
modify a characteristic of the GUI in response to determining that the second parameter exceeds the second threshold.

15. A non-transitory computer readable medium comprising program code, which when executed by a processor is configured to cause the processor to:
receive a clinical data query in an initial format from an input object;
transform the clinical data query into a plurality of different query types, wherein each of the plurality of different query types comprises a different format from the initial format and is for use to query at least one of a plurality of different medical databases;
query each of the plurality of different medical databases using a particular one of the plurality of different query types based on a type of an associated medical database;
receive a plurality of data sets from the plurality of different medical databases, wherein at least one of the plurality of data sets comprises a test result from a particle analyzer; and
output for display at least a portion of each of the plurality of data sets.

16. The non-transitory computer readable medium of claim 15, wherein the clinical data query comprises a first Boolean operator, a second Boolean operator, and a first precedence relationship between the first Boolean operator and the second Boolean operator, the program code further configured to cause the processor to:
detect a user command to change the first precedence relationship between the first Boolean operator and the second Boolean operator of the clinical data query from the first precedence relationship to a second precedence relationship; and
change the first precedence relationship to the second precedence relationship in response to the detected user command;
query at least one of the plurality of different medical databases based on the second precedence relationship;
receive at least one data set based on querying based on the second precedence relationship; and
output at least a portion of the at least one data set.

17. The non-transitory processor readable medium of claim 16, wherein the first Boolean operator has precedence over the second Boolean operator in the first precedence relationship and wherein the second Boolean operator has precedence over the first Boolean operator in the second precedence relationship.

18. The non-transitory computer readable medium of claim 16, further comprising program code which when executed by the processor is configured to cause the processor to:
output for display a graphical user interface (GUI) comprising the input object, wherein the input object comprises an input field; and
output for display the at least the portion of each of the plurality of data sets via the GUI.

19. The non-transitory computer readable medium of claim 18, further comprising program code which when executed by the processor is configured to cause the processor to:
receive a threshold for a parameter of the test result via the GUI, wherein the test result comprises a urinalysis test result and the parameter comprises a white blood cell count or an amount of a bacteria;
determine if the parameter of the test result exceeds the threshold; and
change a color of a GUI component or change a location on a display device of the GUI component in response to determining that the parameter exceeds the threshold.

20. The non-transitory computer readable medium of claim 19, further comprising program code which when executed by the processor is configured to cause the processor to:
receive a second threshold for a second parameter of the test result via the GUI, wherein the second parameter comprises a number of urinary casts;
determine if the second parameter exceeds the second threshold; and
modify a characteristic of the GUI in response to determining that the second parameter exceeds the second threshold.
